(19) United States
(12) Patent Application Publication
(10) Pub. No.: US 2011/0131496 A1
(43) Pub. Date: Jun. 2, 2011

(54) SELECTION OF CONTENT TO FORM A PRESENTATION ORDERED SEQUENCE AND OUTPUT THEREOF

(76) Inventors: David Anthony Shaw Abram, Glasgow (GB); Claudio Ingrosso, Fife (GB); Barry David Mcdonald, Glasgow (GB); Benjamin Nicholas Gray Vaughan, Glasgow (GB)

(21) Appl. No.: 13/057,681

(22) PCT Filed: Aug. 4, 2009
(86) PCT No.: PCT/GB09/01913

§ 371 Date: Feb. 4, 2011

(30) Foreign Application Priority Data
Aug. 6, 2008 (GB) 0814447.9

(51) Int. Cl. G06F 3/01; G06F 3/048

(52) U.S. Cl. 715/722; 715/730

(57) ABSTRACT

A method of selecting content to form a content presentation, the presentation comprising an ordered sequence of selected amounts of content, there being a plurality of items of content available for the presentation, the method comprising: (a) for each of the items of content, determining an associated weight-value based, at least in part, on one or more parameters for the presentation; (b) performing a weighted selection of one of the items of content, the selection being weighted in accordance with the weight-values associated with the items of content; (c) selecting at least a part of the content of the selected item of content to be one of the amounts of content in the ordered sequence of selected amounts of content; and (d) repeating steps (a), (b) and (c) until the presentation is complete.

### FIELD OF THE INVENTION

The present invention relates to forming and/or outputting a presentation of content.

### BACKGROUND OF THE INVENTION

There are many systems, methods and formats for presenting content to a user, wherein the term “content” refers to any type of material (information or data) that may be presented to a user (or that is intended for presentation to a user), such as audio data, video data, audio/video data, image or graphics data, textual data, multimedia data, etc.

Typically, content is presented to a user in a predetermined linear order. For example (i) audio data stored on a CD is presented in the time-linear order in which that audio data is arranged on the CD (e.g. to form a song or music track); (ii) audio and video content stored on a DVD is presented in the time-linear order in which that data is arranged on the DVD (e.g. to form a movie or a film); and (iii) textual data stored in a document is presented in the linear order of its sentences, paragraphs, sections, etc. Whilst some of this content may be stored so that random access can be made to a location in the content (for example, selecting a scene of a film or even skipping to a location within a scene of a film), the content is then played-out, or presented, from that location in the intended linear order.

GB2424351 and WO2008/035022 recognise the limitations of such predetermined linear ordering for content, and present a method and system for storing and arranging a plurality of video segments, and then creating an output video sequence using some or all of those video segments. The segments used to make up the output video sequence are selected at random from the plurality of video segments, although this random selection is controlled by various rules imposed by the system (such as “segment A must always be followed by segment B”). This randomised ordering moves away from the conventional linear ordering, thereby vastly increasing the number of content presentations available from the same amount of content. Additionally, this approach means that a user is very likely to be presented with a video sequence that is different from any video sequence that has been generated previously for him, thereby enhancing the user's interest in that content and preventing the user from becoming bored with that content. For example, different movie endings may result, different story lines may be followed, etc.

However, it would be desirable, and it is one of the objects of the present invention, to provide a more flexible architecture for providing this non-linear randomised content presentation than that described in the above references. It would be desirable for such an architecture to enable more ways for controlling how the content presentation is formed and output, whilst at the same time providing a degree of future-proofing, so that new methods for controlling the formation and output of the content presentation can be easily and quickly introduced and applied.

### SUMMARY OF THE INVENTION

Embodiments of the invention provide for the generation of polymorphic content presentations. A presentation of content (i.e. an ordered sequence of amounts of various material) is generated, using random (or logically unpredictable) selections of content, where the random selection is guided by various factors. The various factors may be controlled by a user, may relate to properties of the system that is executing the embodiment, may relate to environmental factors outside of the control of the user and unrelated to the particular system being used, or may relate to more editorial-style factors or rules that may have been provided by a content creator or a user. These factors provide a logical framework within which the random (or unpredictable) selections of content may be made, i.e. they define a framework or a “select-space” that constrains or limits the random selections that can be made and that logically controls how unpredictable those selections actually are. The selected amounts of content are then used to form an ordered sequence of amounts of content, i.e. a content presentation. Embodiments of the invention allow these factors to be dynamically changed during the generation of the polymorphic content presentation.

According to a first aspect of the invention, there is provided a method of forming a presentation of content, there being a plurality of items of content available for the presentation, the method comprising: (a) for each of the items of content, calculating an associated weight-value based, at least in part, on one or more parameters for the presentation; (b) performing a weighted random selection of one of the items of content, the selection being weighted in accordance with the weight-values associated with the items of content; (c) outputting at least a part of the content of the selected item of content as a part of the presentation; and (d) repeating steps (a), (b) and (c) until the end of the presentation.

According to a second aspect of the invention, there is provided a method of selecting content to form a content presentation, the presentation comprising an ordered sequence of selected amounts of content, there being a plurality of items of content available for the presentation, the method comprising: (a) for each of the items of content, determining an associated weight-value based, at least in part, on one or more parameters for the presentation; (b) performing a weighted selection of one of the items of content, the selection being weighted in accordance with the weight-values associated with the items of content; (c) selecting at least a part of the content of the selected item of content to be one of the amounts of content in the ordered sequence of selected amounts of content; and (d) repeating steps (a), (b) and (c) until the presentation is complete. The weighted selection may be a weighted random selection.

The use of the weight-values and the weighted random selection allows for a flexible approach to performing random selection of content for generating a content presentation, as the weight-values may be calculated or determined based on one or more content selection rules. Additionally, this structure provides a generic framework with which new methods of controlling or influencing the random selection of content can be easily implemented.

The method may comprise allowing at least one of the one or more parameters to be modified whilst the presentation is being formed. In this way, the selection of content for the content presentation may be controlled or influenced dynamically throughout the presentation. Some of these variations or changes to the parameters may result from changes to the system that is implementing the method (for example, its available processing power, available memory or available bandwidth may change). Additionally, some embodiments may comprise allowing a user to modify, whilst the presentation is being formed, at least one of the one or more parameters. In this way, the user himself can dynamically influence the randomised presentation.

In some embodiments, each of the items of content has associated metadata and the calculation/determination of the weight-values is also based on the metadata associated with the items of content. This metadata may be any data representing one or more attributes for the content-items. The method may then comprise determining which parameters to use for step (a) based, at least in part, on the metadata associated with the items of content.

As an example, the metadata associated with at least one item of content may indicate one or more content-types of that item of content, such as an identification of one or more of: a subject-matter of the content of that item of content; a theme for the content of that item of content; and one or more people or characters related to that item of content.

In one embodiment that uses such metadata, for each of the content-types indicated by the metadata for the items of content: there is an associated parameter that indicates a frequency at which items of content of that content-type should be selected; and the weight-values are calculated/determined such that the frequency at which the weighted selection selects items of content of that content-type corresponds to the frequency indicated by the parameter associated with that content-type. Additionally, or alternatively, if the most recently selected item of content is of a first predetermined content-type, then the step of calculating/determining may be arranged to set the weight-value for any item of content of a second predetermined content-type such that the step of performing a weighted selection does not select any item of content of that second predetermined content-type. The second predetermined content-type may be equal to the first predetermined content-type or may be different from the first predetermined content-type. Furthermore, in an embodiment in which one or more of the items of content comprise audio content, the method may comprise adjusting an audio output balance of audio content of a currently selected item of content based on the parameters that indicate a frequency at which items of content of a content-type should be selected. Furthermore, at least one of the content-types for an item of content may identify at least one of: a subject-matter of the content of that item of content; a theme for the content of that item of content; and one or more people or characters related to that item of content.

One or more of the items of content may comprise audio content and the method may then comprise adjusting an audio output balance of audio content of a currently selected item of content based on the parameters that indicate a frequency at which items of content of a content-type should be selected.

The method may comprise determining whether an item of content comprises content related to a current position within the presentation, and if that item of content does not comprise content related to the current position within the presentation then the step of calculating/determining sets the weight-value for that item of content such that the step of performing a weighted selection does not select that item of content.

The method may comprise randomly determining the amount or quantity of to select from the selected content item, i.e. the quantity of content of the selected item of content to output as a part of the presentation. In this way, the method is not restricted to any predetermined partitioning or segmentation of the content-items that has been used by the content-item creator. A user may be allowed to set a lower bound and/or an upper bound on the amount of the content of the selected item of content to output as a part of the presentation.

The content may comprise one or more of: video content; one or more channels of audio content; textual content; graphic content; and multimedia content.

In one embodiment, the items of content are in an encoded form and step (c) comprises decoding the at least part of the content of the selected item of content, and the method comprises: performing step (b) before the output of content of a currently selected item of content has finished in order to select a next item of content; and beginning to decode content of the next item of content such that the decoded content of the next item of content is ready for outputting as a part of the presentation when the output of content of the currently selected item of content has finished. This allows for more accurate selection of specific content from a content-item than might otherwise have been possible, and allows certain data formats (e.g. long-GOP data compression algorithms) to be used more easily.

Step (b) may comprise generating one or more random numbers based on a seed value. The method may then comprise forming a key for the presentation, the key comprising the seed value and an indication of values assumed by the one or more parameters when performing step (a) for the presentation. Additionally, or alternatively, the method may comprise receiving as an input a key for the presentation, the key comprising the seed value and an indication of values which the one or more parameters are to assume when step (a) is performed for the presentation; and using the key to control the presentation, i.e. to control the parameter values when performing step (a).

Performing step (a) may comprise calculating/determining the weight-values based on one or more content selection rules. The content selection rules to use may be determined based, at least in part, on the metadata associated with the items of content.

According to another aspect of the invention, there is provided a method of forming a presentation of content, wherein the presentation of content comprises a plurality of sub-presentations of content and the method comprises forming each sub-presentation using a method according to any one of the preceding methods. According to another aspect of the invention, there is provided a method of forming a presentation of content, wherein the presentation of content comprises a plurality of sub-presentations of content and the method comprises selecting content to form each sub-presentation using any of the above methods. This allows multiple content presentations to be generated in the above randomised ways, and then combined. The sub-presentations may be generated independently of each other, or with some form of synchronisation between them.

The above methods may comprise outputting the presentation to a file or to a user.

According to another aspect of the invention, there is provided a method of outputting video content, there being a plurality of items of video content available and each item of video content is of one or more content-types, the method comprising: for each of the content-types, storing a frequency-indicator for that content-type; performing a weighted random selection of one of the items of video content, the selection being weighted so as to select items of content of a content-type with a frequency in accordance with the value of the frequency-indicator for that content-type; outputting at least a part of the content of the selected item of video content; and repeating the steps of performing and outputting; wherein the method also comprises allowing a user to vary the values of the frequency-indicators during the output of the video content.

According to another aspect of the invention, there is provided a method of outputting a sequence of video content, there being a plurality of items of video content available and each item of video content is of one or more content-types, the method comprising: for each of the content-types, storing a frequency-indicator for that content-type; performing a weighted selection of one of the items of video content, the selection being weighted so as to select items of content of a content-type with a frequency in accordance with the value of the frequency-indicator for that content-type; outputting at least a part of the content of the selected item of video content; and repeating the steps of performing and outputting; wherein the method also comprises allowing a user to vary the values of the frequency-indicators during the output of the video content. The weighted selection may be a weighted random selection.

Any of the above-mentioned methods may comprise performing a weighted selection of a transition from a set of available transitions for transitioning in the content presentation from a selected item of content to a subsequently selected item of content, the selection of the transition being weighted in accordance with one or more of the one or more parameters for the presentation.

According to another aspect of the invention, there is provided a system for forming a presentation of content, the system comprising: storage means storing a plurality of items of content and one or more parameters for the presentation; a content selector for selecting content from the one or more items of content to form a part of the presentation; and an output for outputting the content selected by the content selector as a part of the presentation; the system being arranged to select and output content until the end of the presentation; wherein the content selector comprises: a weight-value calculator for calculating, for each of the items of content, an associated weight-value, the calculation being based, at least in part, on the one or more parameters for the presentation; and a random selector for performing a weighted random selection of one of the items of content, the selection being weighted in accordance with the weight-values associated with the items of content.

According to another aspect of the invention, there is provided a system arranged to select content for forming a content presentation, the presentation comprising an ordered sequence of selected amounts of content, the apparatus comprising: storage means storing a plurality of items of content; a weight-value calculator arranged to calculate, for each of the items of content, an associated weight-value based, at least in part, on one or more parameters for the presentation; a first selector arranged to perform a weighted selection of one of the items of content, the selection being weighted in accordance with the weight-values associated with the items of content; and a second selector arranged to select at least a part of the content of an item of content selected by the first selector to be one of the amounts of content in the ordered sequence of selected amounts of content; wherein the system is arranged to select content until the presentation is complete. The system may be arranged to carry out any one of the above-described methods.

According to another aspect of the invention, there is provided a system for outputting video content, the system comprising: storage means storing a plurality of items of video content, wherein each item of video content is of one or more content-types, the storage means also storing a frequency-indicator for each content-type; a random selector for performing a weighted random selection of one of the items of video content, the selection being weighted so as to select items of content of a content-type with a frequency in accordance with the value of the frequency-indicator for that content-type; an output for outputting at least a part of the content of the selected item of video content; the system being arranged to select and output content until the end of the presentation; wherein the system also comprises a user interface for allowing a user to vary the values of the frequency-indicators during the output of the video content.

According to another aspect of the invention, there is provided a system for outputting a sequence of video content, the system comprising: storage means storing a plurality of items of video content, wherein each item of video content is of one or more content-types, the storage means also storing a frequency-indicator for each content-type; a selector arranged to perform a weighted selection of one of the items of video content, the selection being weighted so as to select items of content of a content-type with a frequency in accordance with the value of the frequency-indicator for that content-type; an output for outputting at least a part of the content of the selected item of video content; the system being arranged to select and output content until the end of the presentation; wherein the system also comprises a user interface arranged to allow a user to vary the values of the frequency-indicators during the output of the video content. The weighted selection may be a weighted random selection.

According to another aspect of the invention, there is provided a computer program which, when executed by a computer, carries out any one of the above-described methods. The computer program may be stored, or carried, on a data carrying medium. This medium may be a storage medium (such as a magnetic or optical disk, a solid-state storage device, a flash-memory device, etc.) or a transmission medium (such as a signal communicated over a network).

### BRIEF DESCRIPTION OF THE DRAWINGS

Embodiments of the invention will now be described, by way of example only, with reference to the accompanying drawings, in which:

FIG. 1 schematically illustrates an example system according to an embodiment of the invention;

FIG. 2 schematically illustrates some of the data flow and data processing according to an embodiment of the invention;

FIG. 3 is a flowchart of the processing for the embodiment illustrated in FIG. 2;

FIG. 4 schematically illustrates some of the data flow and data processing according to another embodiment of the invention;

FIG. 5 is a flowchart of the processing for the embodiment illustrated in FIG. 4;

FIG. 6 schematically illustrates an exemplary format for a content-file according to an embodiment of the invention;

FIG. 7 schematically illustrates the structure of a content selection module and its data flows according to an embodiment of the invention;

FIG. 8 is a flow diagram illustrating the processing performed by a content presentation software application in conjunction with the content selection module shown in FIG. 7; and

FIG. 9 schematically illustrates a user interface provided by a content presentation software application according to an embodiment of the invention.

### DETAILED DESCRIPTION OF EMBODIMENTS OF THE INVENTION

In the description that follows and in the figures, certain embodiments of the invention are described. However, it will be appreciated that the invention is not limited to the embodiments that are described and that some embodiments may not include all of the features that are described below. It will be evident, however, that various modifications and changes may be made herein without departing from the broader scope of the invention as set forth in the appended claims.

### Overview

In summary, embodiments of the invention provide a method of delivering a presentation of content to a user, together with a method for controlling what content makes up that presentation. A plurality of content-items are made available for use in the presentation. Each of the content-items has its own respective content, and content from some or all of these content-items is presented to the user as part of the presentation. The selection of which content-items (and also potentially the selection of the particular content from those selected content-items) to present to the user is at least partly randomised. However, this randomisation is guided or influenced in accordance with a number of parameters set up for the presentation. Some of these parameters may be based on input received from the user.

Herein, the term “content” refers to any type of material (information or data) that may be presented to a user (or that is intended for presentation to a user), such as audio data, video data, audio/video data, image or graphics data, textual data, multimedia data, etc. The term “content-item” is a discrete instance, amount, quantity or item of content, such as: a piece of audio data (e.g. a song, a soundtrack, a tune, voice data, music, etc.), which may comprise one or more channels of audio data; a piece of video data (e.g. a whole film/movie, a scene or clip from a video sequence, etc.); a piece of combined audio and video data (e.g. a segment from a music video having the music audio and associated video frames); one or more images; one or more graphic elements (e.g. icons, logos, animation sequences, etc.); a document having text and possibly embedded graphical elements; etc. A content-item may be stored as one or more files and/or stored in one or more areas of memory, and acts as a container for content data. The content-items available for the presentation may be of one or more types, such as one or more of the above example types (e.g. (i) an audio content-item having a soundtrack for a music video and (ii) a plurality of video content-items each having a video sequence for the music video, with these video sequences having been captured by different video cameras positioned at different locations). A content presentation then comprises an ordered sequence, or an arrangement, of selected amounts of content, each amount of content being a quantity of content that has been selected from a respective content-item.

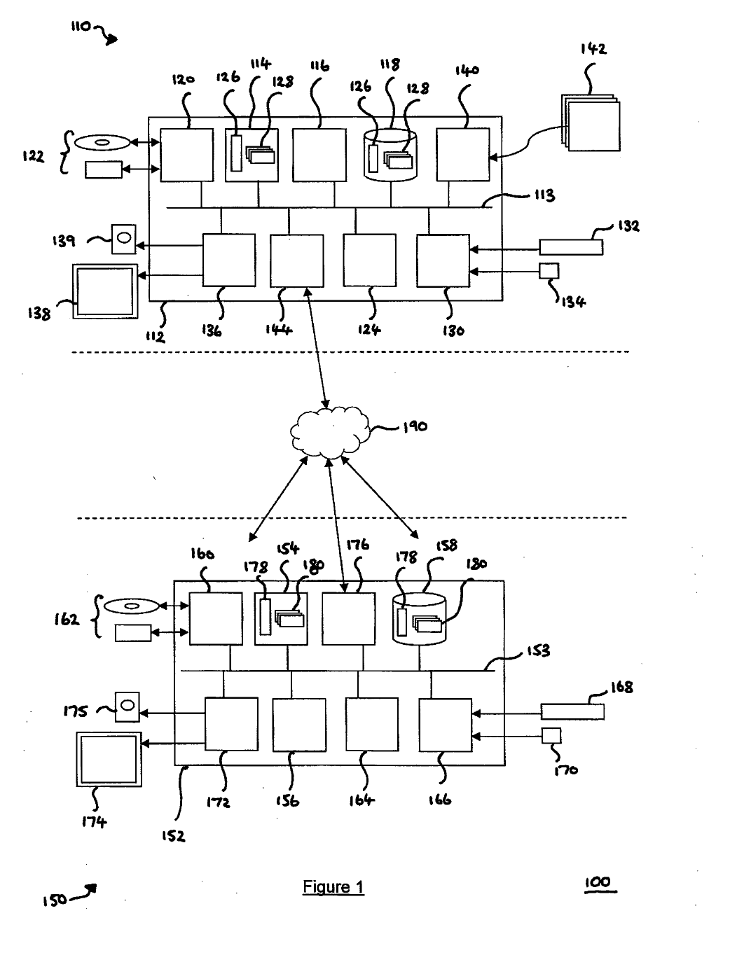

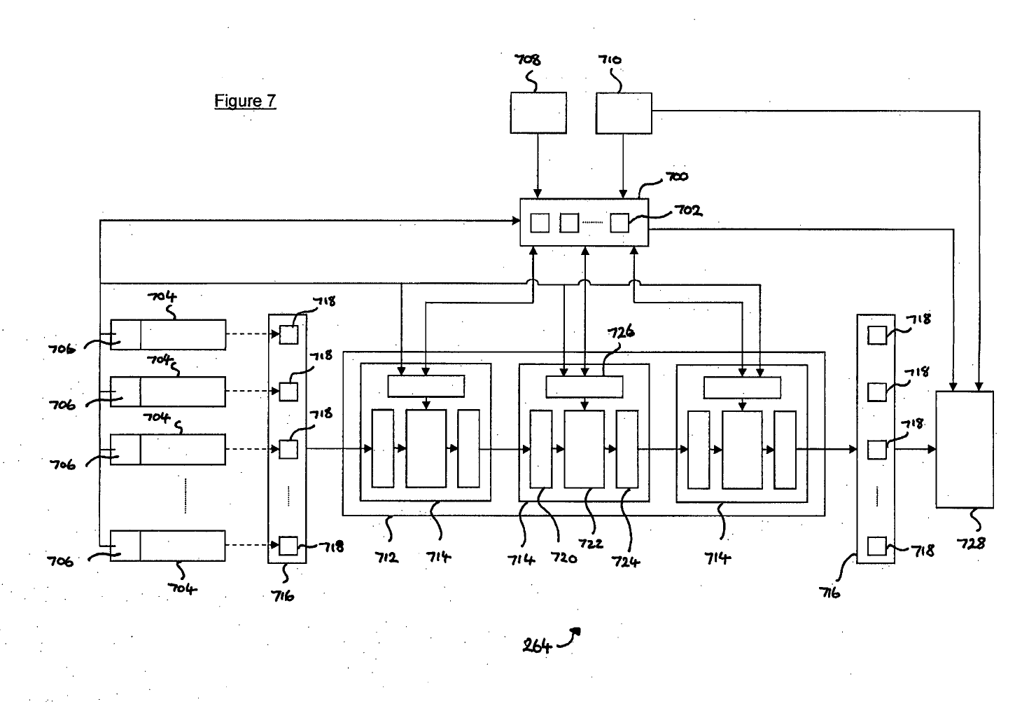

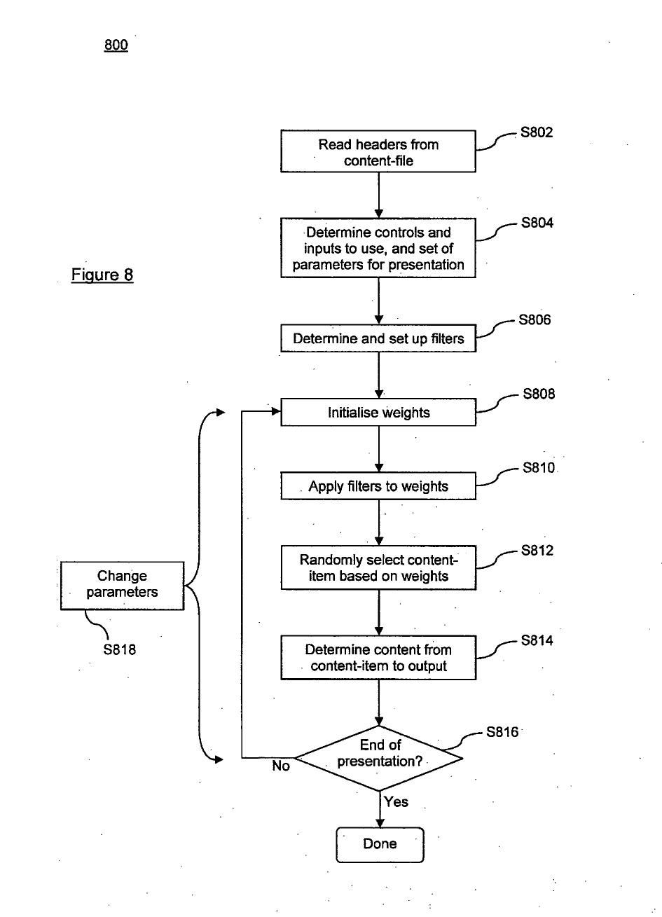

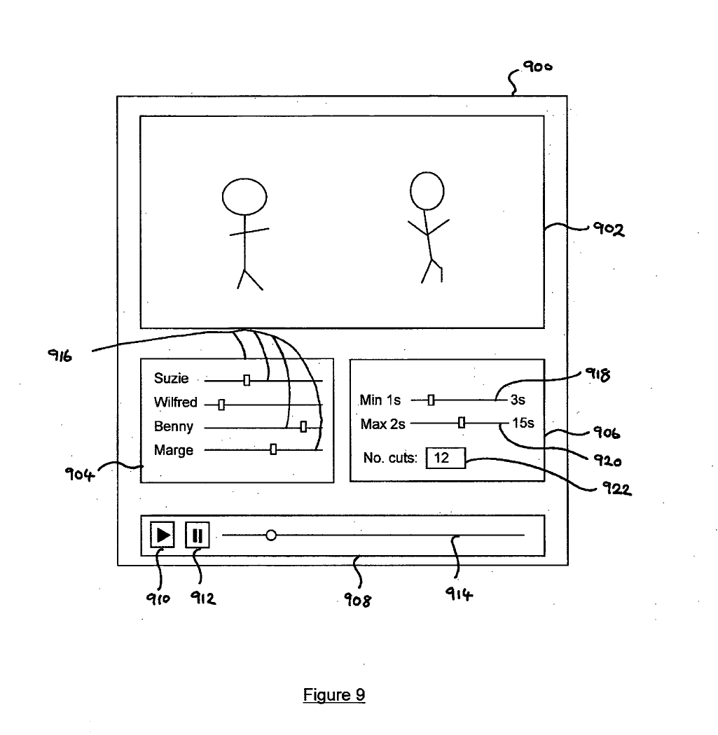

Some embodiments of the invention are arranged to deliver the plurality of content-items to the user, with the user then receiving the presentation of content from locally stored content-items. Other embodiments of the invention are arranged to store the content-items remotely from the user, with the user then receiving the presentation of content from the remotely stored content-items. FIGS. 1-6 and their associated descriptions below provide example systems and file formats for achieving this. However, it will be appreciated that other systems and file formats could be used, and that embodiments of the invention simply need the plurality of content-items to be available for presentation to the user, whilst providing the ability to control or influence the nature of the presentation. FIGS. 7 and 8 and their associated descriptions then provide details of an embodiment for controlling or influencing the presentation of content from the content-items that have been made available for the presentation. FIG. 9 provides a particular example system that makes use of the embodiment shown in FIGS. 7 and 8.

### Exemplary Systems and Formats

FIG. 1 schematically illustrates an example system 100 according to an embodiment of the invention. The system 100 comprises a content provider system 110 in communication with a user system 150 over a network 190. As a high level overview, the content provider system 110 may assimilate and/or collate and/or generate content and then communicate (or provide) that content, in a suitable form, to the user system 150 over the network 190. A user at the user system 150 may then view or use some or all of the content that has been received at the user system 150. Embodiments of the invention help control the way in which some or all of the content is presented to the user. As discussed in more detail later, this control of the presentation may be carried out either at the content provider system 110 or at the user system 150.

The network 190 may be any network suitable for communicating data between the content provider system 110 and the user system 150, such as the Internet, a local area network, a wide area network, a metropolitan area network, a mobile telecommunications network, a television network, a satellite communications network, etc. It will be appreciated that, until the content provider system 110 is ready to communicate data to the user system 150, then the content provider system 110 may operate without being connected to the network 190. Similarly, it will be appreciated that once the user system 150 has received the relevant data from the content provider system 110, then the user system 150 may operate without being connected to the network 190.

An example architecture for the content provider system 110 is illustrated in FIG. 1. The content provider system 110 comprises a computer 112. The computer 112 comprises a number of components, namely: a non-volatile memory 114 (such as a read-only-memory); a volatile memory 116 (such as a random-access-memory); a storage medium 118 (such as one or more hard disks); an interface 120 for reading data from and/or writing data to one or more removable storage media 122 (such as flash memory devices and/or optical disks and/or magnetic disks, etc.); a processor 124 (which may actually comprise one or more processors operating in parallel); a user-input interface 130; an output interface 136; a content-input interface 140; and a network interface 144. The computer 112 also comprises one or more buses 113 for communicating data and/or instructions and/or commands between the above components, and which allow these components to request or retrieve data from, or send or provide data to, other components of the computer 112.

As is known, the non-volatile memory 114 and/or the storage medium 118 may store one or more files 126 (or modules) that form an operating system for the computer 112 that is executed (or run) by the processor 124. In doing so, the processor 124 may make use of the volatile memory 116 and/or the storage medium 118 to store data, files, etc. Additionally, the non-volatile memory 114 and/or the storage medium 118 and/or the removable storage media 122 may store one or more files 128 (or modules) which form one or more software applications or computer programs for the processor 124 to execute (or run) to carry out embodiments of the invention. This is described in more detail later. In doing so, the processor 124 may make use of the volatile memory 116 and/or the storage medium 118 to store data, files, etc.

The user-input interface 130 allows a user to provide an input (e.g. data and/or commands) to the processor 124. The user-input interface 130 may receive input from a user via a variety of input devices, for example, via a keyboard 132 and a mouse 134, although it will be appreciated that other input devices may be used too. The output interface 136 may receive display data from the processor 124 and control a display 138 (such as an LCD screen or monitor) to provide the user with a visual display of the processing being performed by the processor 124. Additionally, or alternatively, the output interface 136 may receive audio data from the processor 124 and control one or more speakers 139 (which may be integral with the display 138) to provide the user with audio output.

The network interface 144 enables the computer 112 to receive data from other devices or locations via the network 190, and to communicate or transmit data to other devices or locations via the network 190.

The content used by the computer 112 and provided by the computer 112 may be stored in a variety of places. For example, the computer 112 may store content as one or more files in the volatile memory 116 and/or the storage medium 118 and/or a removable storage medium 122. Additionally, or alternatively, the computer 112 may store content as one or more files at a location (not shown in FIG. 1) accessible by the computer 112 via the network 190. Furthermore, content may be stored at, or may be accessible via, one or more dedicated content storage, or content capture, devices 142 (such as video tape recorders, video cameras, audio recorders, microphones, etc.). The content-input interface 140 therefore provides an interface to such devices 142 and allows the processor 124 to access content from such devices 142. The processor 124 may, for example, store content accessed from a device 142 as one or more files on the storage medium 118.

The computer 112 may be any form of computer capable of performing the processing and tasks described later. For example, the computer 112 may comprise one or more desktop computers, personal computers, server computers, etc. Additionally, the content provider system 110 may comprise a plurality of computers 112 in communication with each other, instead of the single computer 112 shown in FIG. 1. For example, as described in more detail later, the content provider system 110 may provider a webserver aspect and a content generator/formatter aspect, and so may comprise one or more server computers 112 for performing the webserver aspect and one or more desktop computers 112 for performing the content generator/formatter aspect.

Similarly, an example architecture for the user system 150 is illustrated in FIG. 1. The user system 150 comprises a computer 152. The computer 152 comprises a number of components, namely: a non-volatile memory 154 (such as a read-only-memory); a volatile memory 156 (such as a random-access-memory); a storage medium 158 (such as one or more hard disks); an interface 160 for reading data from and/or writing data to one or more removable storage media 162 (such as flash memory devices and/or optical disks and/or magnetic disks, etc.); a processor 164 (which may actually comprise one or more processors operating in parallel); a user-input interface 166; an output interface 172; and a network interface 176. The computer 112 also comprises one or more buses 153 for communicating data and/or instructions and/or commands between the above components, and which allow these components to request or retrieve data from, or send or provide data to, other components of the computer 152.

As is known, the non-volatile memory 154 and/or the storage medium 158 may store one or more files 178 (or modules) that form an operating system for the computer 152 that is executed (or run) by the processor 164. In doing so, the processor 164 may make use of the volatile memory 156 and/or the storage medium 158 to store data, files, etc. Additionally, the non-volatile memory 154 and/or the storage medium 158 and/or the removable storage media 162 may store one or more files 180 (or modules) which form one or more software applications or computer programs for the processor 164 to execute (or run) to carry out embodiments of the invention. This is described in more detail later. In doing so, the processor 164 may make use of the volatile memory 156 and/or the storage medium 158 to store data, files, etc.

The user-input interface 166 allows a user to provide an input (e.g. data and/or commands) to the processor 164. The user-input interface 166 may receive input from a user via a variety of input devices, for example, via a keyboard 168 and a mouse 170, although it will be appreciated that other input devices may be used too. The output interface 172 may receive display data from the processor 164 and control a display 174 (such as an LCD screen or monitor) to provide the user with a visual display of the processing being performed by the processor 164. Additionally, or alternatively, the output interface 172 may receive audio data from the processor 164 and control one or more speakers 175 (which may be integral with the display 174) to provide the user with audio output.

The network interface 176 enables the computer 152 to receive data from other devices or locations via the network 190, and to communicate or transmit data to other devices or locations via the network 190.

The content used by the computer 152 and provided to the computer 152 may be stored in a variety of places. For example, the content may be stored as one or more files in the volatile memory 156 and/or the storage medium 158 and/or a removable storage medium 162. Additionally, or alternatively, the computer 152 may receive content as one or more files from a location (not shown in FIG. 1) accessible by the computer 152 via the network 190.

The computer 152 may be any form of computer capable of performing the processing and tasks described later. For example, the computer 152 may comprise one or more desktop computers, personal computers, server computers, mobile telephones, laptops, personal digital assistants, personal media players, etc. Additionally, the user system 150 may comprise a plurality of computers 152 in communication with each other, instead of the single computer 152 shown in FIG. 1.

Whilst only one content provider system 110 and one user system 150 is shown in FIG. 1, it will be appreciated that a user system 150 may communicate with multiple content provider systems 110 and that a content provider system 110 may provide content to multiple user systems 150.

It will be appreciated that other architectures may be used for the content provider system 110 and the user system 150. For example, the content provider system 110 could provide content to the user system 150 via a storage medium (such as an optical disk) instead of via the network 190, or indeed via any suitable data delivery/communication mechanism. Additionally, the provision of content to the user system 150 may involve one or more intermediaries between the content provider system 110 and the user system 150. In general though, the content provider system 110 is either (i) arranged to communicate content in a suitable format to the user system 150 so that the user system 150 can execute one or more software applications that control the formation and/or presentation of that content or (ii) is arranged itself to control the formation and/or presentation of the content and provide the controlled content presentation to the user system 150. This is described in more detail below.

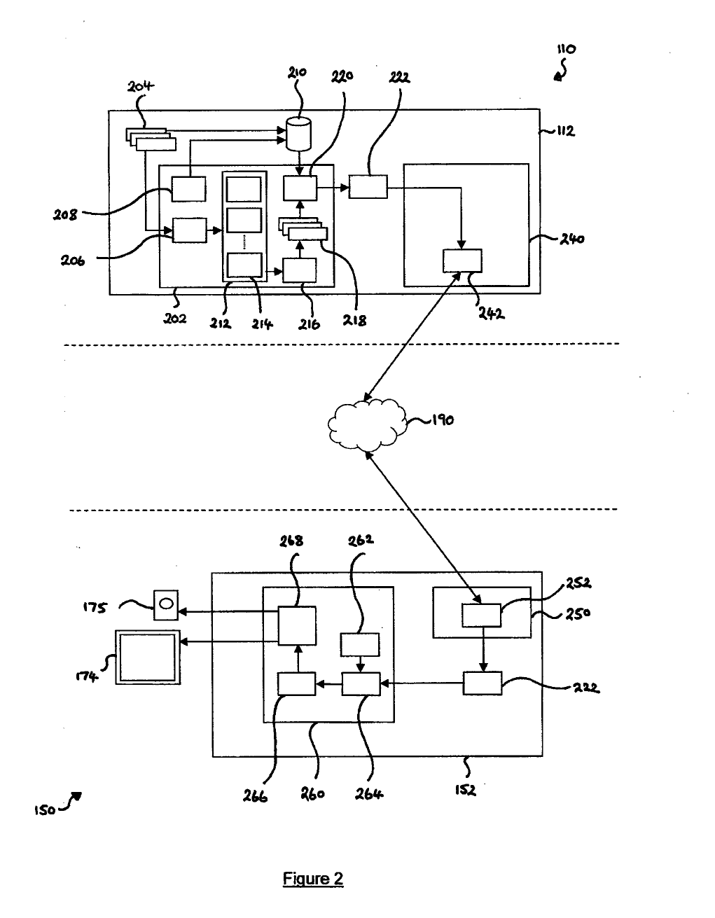

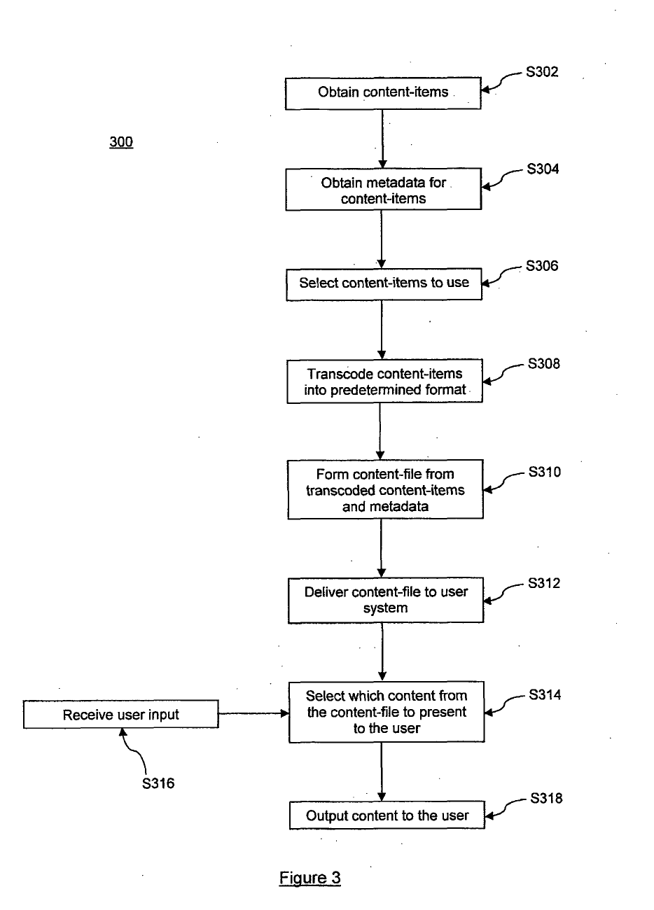

FIG. 2 schematically illustrates some of the data flow and data processing according to an embodiment of the invention. FIG. 3 is a flowchart of the processing 300 for the embodiment illustrated in FIG. 2.

The files 128 of the content provider system 110 provide a content-file generation software application 202 and a content delivery software application 240, both executable by the processor 124 of the computer 112. Similarly, the files 180 of the user system 150 provide a content receiver software application 250 and a content presentation software application 260, both executable by the processor 164 of the computer 152. The content-file generation software application 202 is responsible for generating a content-file 222 (the nature of which will be described later), and the content delivery software application 240 works in communication with the content receiver software application 250 to deliver the content-file 222 from the content provider system 110 to the user system 150. The content presentation software application 260 is then responsible for forming a content presentation, presenting content to the user, and controlling how that content is presented to the user. The operation of the content-file generation software application 202, the content delivery software application 240, the content receiver software application 250 and the content presentation software application 260 is illustrated by the processing 300 of FIG. 3.

The generated content-file 222 may be stored by the computer 112 (for example, on the storage medium 118) prior to being delivered by the content delivery software application 240 to the user system 150. Alternatively, the content delivery software application 240 may be coupled to the content-file generation software application 202 so as to take the content-file 222 as an input directly from the content-file generation software application 202; for example, the content delivery software application 240 and the content-file generation software application 202 may form part of a single executable software application executed by the processor 124.

Similarly, the generated content-file 222 received at the user system 150 may be stored by the computer 152 (for example, on the storage medium 158) prior to being used by the content presentation software application 260 to present content to the user. Alternatively, the content presentation software application 260 may be coupled to the content receiver software application 250 so as to take the content-file 222 as an input directly from the content receiver software application 250; for example, the content receiver software application 250 and the content presentation software application 260 may form part of a single executable software application executed by the processor 164.

Execution of the content-file generation software application 202 begins at a step S302, at which the content provider system 110 obtains a plurality of initial content-items. One or more of these content-items may have been generated at the content provider system 110 itself, and may be stored as corresponding files 204 at the computer 112 (for example, on the storage medium 118). One or more of the content-items may be stored as one or more files 204 on a removable storage medium 122 or at a location or device accessible via the network 190. In this case, these files 204 may simply be accessed directly from the removable storage medium 122 or via the network 190, whilst in other embodiments, these files 204 may be copied to the computer 112 for processing, so that they are stored locally at the computer 112 (for example, on the storage medium 118). One or more of the content-items may be received from one of the devices 142. In this case, the content-input interface 140 may need to process the signals received from that device 142 (for example, analogue-to-digital conversion, decryption, etc.) before storing the content provided by that device 142 as a file 204 on the computer 112 (for example, on the storage medium 118).

As such the content-file generation software application has available to it a plurality of content-items, stored as one or more files 204 on a storage medium or in memory.

At a step S304, metadata is obtained and associated with each of the content-items. Some of this metadata may have been automatically generated as part of the creation process for that content-item. For example, the metadata may include date/time information regarding when a content-item was created or generated, or geographical data regarding the location at which a content-item was created or generated, or data identifying settings of recording (capture) equipment used to record (or capture) the content (such as video camera settings). This metadata may be stored alongside the content-item as part of the file 204 for that content-item, in which case the content-file generation software application 202 may be arranged to automatically extract such metadata from that file 204. Alternatively, such metadata may be provided as a separate file associated with the file 204 for that content-item.

Other metadata may be input by a human (such as an operator of the content provider system 110), such as a description of the subject-matter of the content-item or an identification of one or more people to whom that content-item relates (such as the name of the actors or performers who appear in an image or a video sequence or an audio track). As such, the content-file generation software application 202 may include a module 208 for allowing an operator of the computer 112 to input metadata and associate that metadata with a content-item.

Other types of metadata shall be described later in relation to further example embodiments of the invention. However, it will be appreciated that the metadata associated with a content-item may be data concerning any aspect or attribute of that content-item.

The metadata for the content-items may be stored in a database 210 on the computer 112 or may be stored in a file 210 (for example, in an XML file) at the computer 112.

At a step S306, a plurality of the content-items are selected by an operator of the computer 112 for use in generating the content-file 222. The content-file generation software application 202 may therefore include a content-item selection module 206 that allows a user to select content-items that are accessible by the computer 112.

As the selected content-items may be in several different formats (such as different data compression formats or different file formats), a step S308 is provided to transcode all of the selected content-items into one or more predetermined formats. As such, the content-file generation software application 202 may include a set 212 of one or more decoder modules 214, there being one decoder module 214 for each format supported by the content-file generation software application 202. For each of the selected content-items, a decoder module 214 corresponding to the format of that selected content-item decodes that selected content-item to extract its content (for example, by decompressing compressed data into raw content data, or extracting raw content data from a particular file format). The content-file generation software application 202 also has an encoder module 216 for re-encoding the decoded content-items into the predetermined format(s). In this way, the content-file generation software application 202 generates a plurality of content-item files 218 having the content of the originally selected content-items converted into the predetermined format(s). The content-item files 218 may be files stored in the storage medium 128 or simply data stored in the volatile memory 126.

It will be appreciated that, if a content-item is already in the predetermined format, then that content-item need not undergo the above-described decoding and re-encoding.

It will also be appreciated that the predetermined format may be based on the type of the content-item. For example, there may be a predetermined format for audio data (such as the well-known AAC or MP3 audio formats) and a predetermined format for video data (such as the well-known H264 or MPEG4 video formats).

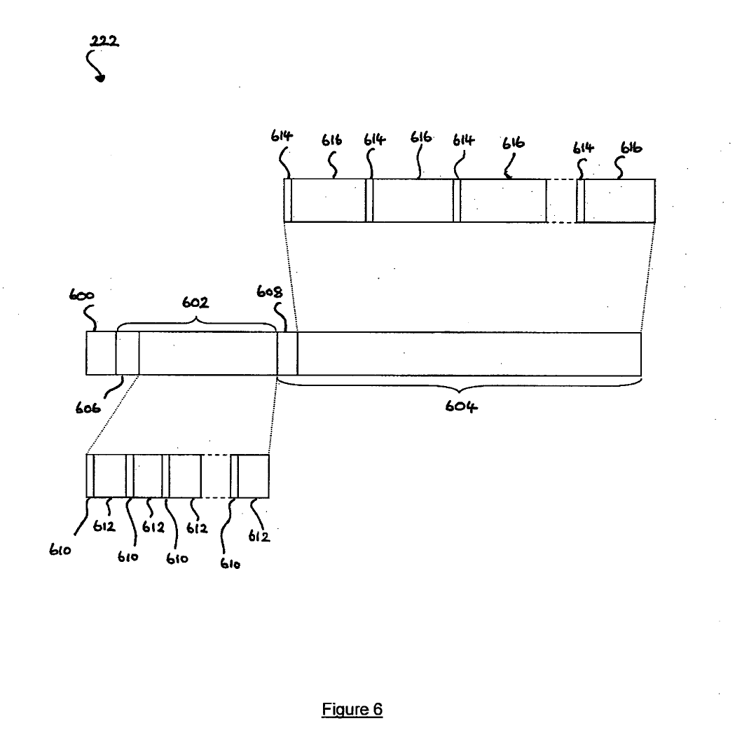

A combining module 220 of the content-file generation software application 202 then combines (at a step S310) the plurality of content-item files 218 and the metadata associated with the content-items of those files 218 to form a single file, i.e. the content-file 222. An example format of a content-file 222 having data for audio and video content-items is described later with reference to FIG. 6. However, it will be appreciated that any format may be used for the content-file 222.

Once the content-file 222 has been generated, at a step S312 the content delivery software application 240 may be used to provide the content-file 222 to the user system 150 via the network 190. This may be achieved in a variety of ways. For example: (a) the content delivery software application 240 may host a website 242 from which the user of the user system 150 may download the content-file 222; (b) the content provider system 110 may comprise a file server 242 from which the content delivery software application may access the content-file 222; or (c) the content delivery software application 240 may be arranged to send-out (transmit or communicate) the content-file 222 to a user system 150 without waiting to receive a prompt from the user system 150 for the content-file 222.

Similarly, at the step S312, the content receiver software application 250 may be used to receive the content-file 222 from the content provider system 110 via the network 190. This may be achieved in a variety of ways. For example: (a) the content receiver software application 250 may comprise a browser application 252 via which the user can access a website 242 hosted by the content provider system 110 and from which the content-file 222 may be downloaded; (b) the content receiver software application 250 may comprise a module 252 via which the user can access a file server 242 of the content provider system 110 and from which the content-file 222 may be downloaded; or (c) the content receiver software application 250 may be arranged to wait for and receive communications (e.g. the content-file 222) that the content provider system 110 sends-out (transmits or communicates) without having waited for a prompt or request from the user system 150.

It will be appreciated, though, that the content-file 222 may be delivered to the user system 150 in a variety of other ways and that, indeed, the content-file 222 need not be communicated to the user system 150 via the network 190 but could, for example, be saved on a removable storage medium 122 which is then delivered (e.g. by mailing) to the user system 150, with the user system 150 then accessing the content-file 222 from that removable storage medium 122.

Having received the content-file 222, the computer 152 at the user system 150 may store the content-file 222 on the storage medium 158.

When the user of the user system 150 wishes to be presented with content from the content-file 222 (i.e. “play” the content-file 222), then the user launches the content presentation software application 260. The content presentation software application 260 comprises a content selection module 264 for selecting (at a step S314) the particular content from the content-file 222 that is to form the content presentation and that is to be presented to the user. Methods by which the content selection module 264 selects content shall be described in more detail later. However, the content presentation software application 260 may comprise a user interface module 262 via which the user can vary one or more parameters for the content presentation (at a step S316) before and during the presentation of the content. The content selection module 264 receives input from the user in the form of these one or more parameters, and the selection of the content to present is influenced or controlled in accordance with these parameters.

A decoder module 266 of the software presentation module 260 then decodes the content selected by the content selection module 264. This may take the form of performing data decompression and/or extracting data from a particular data format. The decoder module 266 performs decoding based on the one or more predetermined formats used by the encoder module 216.

A renderer module 268 of the software presentation module 260 then presents (at a step S318) the decoded content to the user (for example, by providing decoded content data in a suitable format to the output interface 172 for output via the display 174 and/or the speakers 175).

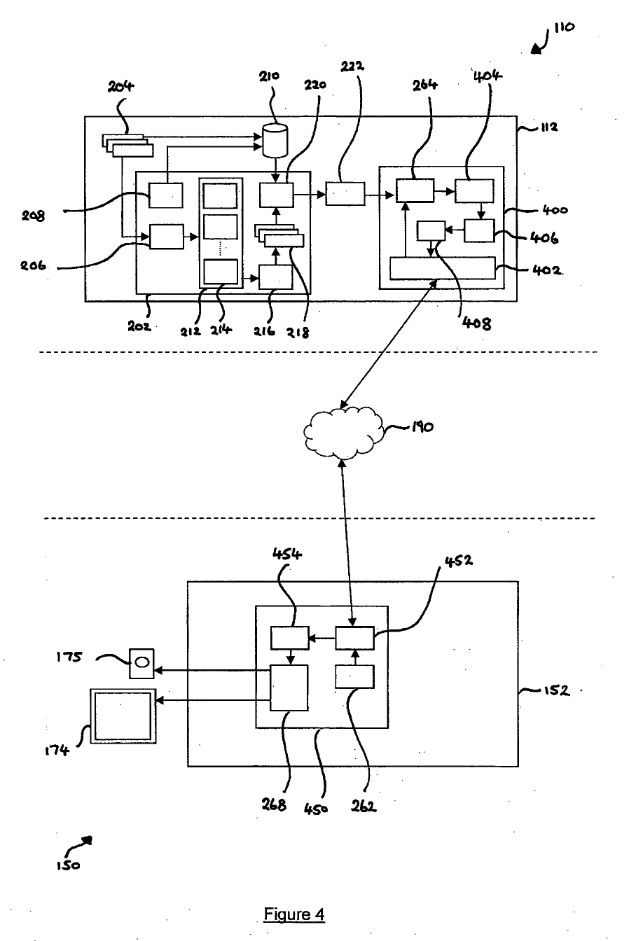

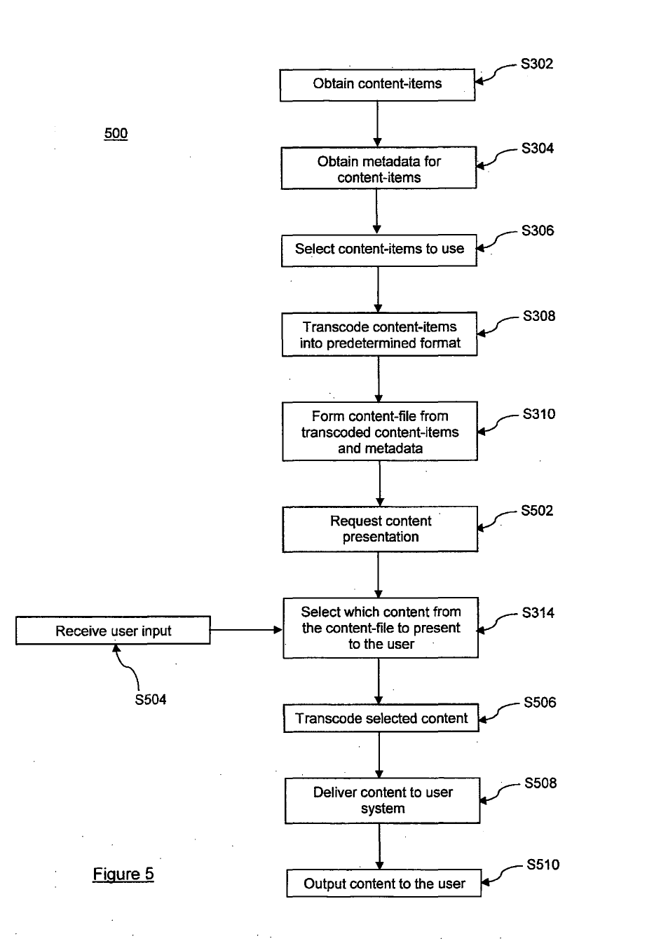

FIG. 4 schematically illustrates some of the data flow and data processing according to another embodiment of the invention. FIG. 5 is a flowchart of the processing 500 for the embodiment illustrated in FIG. 4. The embodiment illustrated in FIG. 4 has many components in common with those of the embodiment illustrated in FIG. 2, and such components are therefore given the same reference numeral and shall not be described again. Similarly, the processing 500 in FIG. 5 has many steps in common with the processing 300 in FIG. 3, and such steps are therefore given the same reference numeral and shall not be described again. In summary, though, the content-file 222 is generated in the embodiment of FIGS. 4 and 5 in the same way as in the embodiment of FIGS. 2 and 3. The difference between these embodiments is in the manner of delivery of content to the user system 150 and the formation and control of the presentation of the content.

In FIG. 4, the files 128 of the content provider system 110 provide the content-file generation software application 202 and a content delivery software application 400, both executable by the processor 124 of the computer 112. Similarly, the files 180 of the user system 150 provide a content presentation software application 450 executable by the processor 164 of the computer 152. As before, the content-file generation software application 202 is responsible for generating a content-file 222 (the nature of which will be described later), and the content delivery software application 400 works in communication with the content presentation software application 450 to deliver (e.g. stream) content contained in the content-file 222 from the content provider system 110 to the user system 150. The operation of the content-file generation software application 202, the content delivery software application 400, and the content presentation software application 450 is illustrated by the processing 500 of FIG. 5.

In contrast to the embodiment of FIGS. 2 and 3, the generated content-file 222 is stored by the computer 112 (for example, on the storage medium 118) but it is not communicated as a whole file to the user system 150. Instead, selected content from the content-file 222 is communicated (e.g. streamed) to the user system 150.

The content-file generation software application 202 generates the content-file in the same way as described with reference to FIGS. 2 and 3 (i.e. the steps S302 to S310 are carried out).

The content delivery software application 400 comprises a server module 402 for providing server (e.g. web-server) functionality to the content delivery system 110. Similarly, the content presentation software application 402 comprises a client module 452 for providing client (e.g. web-client) functionality to the user system 150. The server module 402 and the client module 452 may be any known server/client modules with which a server-client session may be established over the network 190 between the content provider system 110 and the user system 150.

The content presentation software application 450 allows the user to request a presentation of content (from the content-file 222) from the content provider system 110 (at a step S502). The content presentation software application 450 may also comprise the user interface module 262 via which the user can vary (at a step S504) one or more parameters for the content presentation before and during the presentation of the content. These parameters and/or the user variation of these parameters may be communicated to the content delivery software application 400 via the network 190.

The content delivery software application 400 comprises the content selection module 264. At the step S314, the content selection module 264 selects the particular content from the content-file 222 that is to be communicated to the user system 150 for presentation to the user. As in the embodiment of FIGS. 2 and 3, the content selection module 264 may make use of the user-controllable parameters, with updates to the parameters being received over the network 190 from the user interface module 262.

At a step S506, the selected content is transcoded from the predetermined format(s) that were used by the encoder module 216 into a format suitable for transmission (e.g. streaming) over the network 190 for play-out or presentation at the user system 150. A decoder module 404 of the content delivery software application 400 decodes the selected content from the predetermined format(s) that were used by the encoder module 216 to produce decoded content data 406 which is then re-encoded by an encoder module 408 of the content delivery software application into a format suitable for streaming over the network 190 to the user system 150. For example, this may involve decompressing and re-compressing the selected content so that the data rate of the selected content matches the transmission data rate (or bandwidth) available from the content delivery system 110 to the user system 150. Additionally, the transcoding step S506 may take into account the abilities (e.g. processing power, video display resolution, number of audio channels that can be output, etc.) of the user system 150 so that the content delivered to the user system 150 is suitable for presentation at the user system 150. At a step S508, the server module 402 then delivers (e.g. streams) the selected content to the user system 150 over the network 190. It will be appreciated that the above decoding and re-encoding may be omitted if the content is already in a suitable format for transmitting to the user system 150.

The content presentation software application 450 comprises a decoder module 454 that decodes the received content. This may take the form of performing data decompression and/or extracting data from a particular data format. The decoder module 454 performs decoding based on the formats used by the encoder module 408.

The content presentation software application 450 comprises the renderer module 268 that presents (at a step S510) the decoded content to the user (for example, by providing decoded content data in a suitable format to the output interface 172 for output via the display 174 and/or the speakers 175).

It will be appreciated that the first embodiment (illustrated in FIGS. 2 and 3) and the second embodiment (illustrated in FIGS. 4 and 5) have their own advantages. For example, by storing the content-file 222 locally at the user system 150, the first embodiment does not rely on a network connection between the user system 150 and the content provider system 110 during the presentation of the content. Additionally, this reduces the data communication load placed on the content provider system 110. On the other hand, the second embodiment, by storing the content-file 222 locally at the content provider system 110 and controlling the selection of content at least in part at the content provider system 110, allows the content presentation software application 450 to be smaller, as more processing can be performed at the content provider system 110. Additionally, this allows updates to file formats, data compression formats, etc. to be more easily handled at the more central content provider system 110, rather than having to update each user system 150. It will be appreciated that other system structuring and architectures could be used, each having their own advantages and disadvantages. However, as mentioned, such systems simply need to make the plurality of content-items available for forming a content presentation for presentation to the user.

FIG. 6 schematically illustrates an exemplary format for the content-file 222 according to an embodiment of the invention in which the content-items are a mixture of audio content-items and video content-items. It will be appreciated, though, that a similar format may be used for content-files 222 that contain other types of one or more content-items. It will also be appreciated that a content-file 222 need not make use of the format illustrated in FIG. 6.

In the example shown in FIG. 6, the content-file 222 begins with a file header 600. Content-items of a particular type are grouped together in a corresponding contiguous section of the content-file 222. Therefore, in the example of FIG. 6 in which there are audio content-items and video content-items, there is an audio section 602 of the content-file 222 following the file header 600. The audio section 602 is itself then followed by a video section 604. Each of the typed-sections (audio section 602 and video section 604 in FIG. 6) begins with its own section header (audio section header 606 and video section header 608). The section header 606, 608 is followed by the respective content-items, each of the content-items being preceded by its own content-item header (e.g. pairings of audio content-item headers 610 and their corresponding audio content-items 612; and pairings of video content-item headers 614 and their corresponding video content-items 616).

The file header 600 may contain information which generally relates to the content-file as a whole, such as:
the size of the file header 600;
the number of content-items of each type, for example, the number of audio content-items 612 and the number of video content-items 616;
the start location/address within the content-file 222 of each type section, for example, the address of the audio section 602 and the address of the video section 604;
data for user-controllable parameters, for example, one or more of: parameter name, description, user-interface information (e.g. whether the user controls the parameter via a slider-bar, check-box, input-box, etc.), minimum value, maximum value, default value, etc.—the use of this will be described in more detail later;
an indication of which filters (see later) to use for forming the content presentation;
a title for the content-file 222;
credits for the content-file 222; and
copyright information for the content-file 222.

Each section header 606, 608 for a particular content-item type may contain the information which generally relates to the content-items of that type, such as:
size of the section header 606, 608; and
the start location/address within the content-file 222 of each content-item header 610, 614 in the respective content-item section 602, 604.

Each of the content-items headers 610, 614 contains information about its corresponding content-item 612, 616, such as:
size of the content-item header 610, 614;
data compression format used, for example, compression parameter and/or profiles for a data compression format;
data rate, for example, number of video frames or fields per second or number of audio samples per second;
data resolution, for example, number of bits used per audio sample and the number of audio channels, or the number of pixels per video frame and the dimensions of a video frame;
metadata (obtained at the step S304) relating to that content-item 610, 614.

Each content-item itself then contains the relevant content data for that content-item (such as one or more video frames or fields for video content-items 616, or one or more audio samples for audio content-items 612).

It will be appreciated that there are many variants of the above-described systems, methods, processing and formats. For example, embodiments of the invention need not necessarily use metadata in association with content-items, so that the above-described aspects relating to metadata may be omitted.

Additionally, whilst the above embodiments have been described as generating and using a single content-item file 222, it will be appreciated that content-items may be stored in, and used from, a plurality content-item files 222. Some of these content-item files 222 may carry links that reference related content-items files 222. For example, a content-item file may be provided for audio content, a content-item file may be provided for related video content, and a content-item file may be provided for related textual content, and these content-item files may refer to each other (e.g. via a URL or a pathname).

Additionally, the use of one or more predetermined formats and the use of the transcoding step S308 may be omitted. However, using the predetermined formats and the transcoding step S308 helps reduce the number of formats that need to be supported, reduces the size of the software applications, helps future-proof the software applications against the introduction of new formats (to support a new format, the set 212 of decoder modules 214 simply needs to be expanded to accommodate a new decoder module 214 for that new format, whilst the user system 150 needs no modification) and can help make switching from a currently selected content-item to the next selected content-item easier and smoother.

Additionally, the use of the transcoding step S506 may be omitted. However, using the transcoding step S506 facilitates smooth and seamless presentation of content to the user at the user system 150, as the data rate of the communication of content from the content provider system 110 to the user system 150 can be matched to the properties (e.g. bandwidth) of the network communication and the abilities of the user system 150 (for example, if the user system 150 is a mobile telephone, then its processing abilities and display resolution will be lower than those of a desktop computer, so that the data-rate and video resolution of content provided to the mobile telephone user systems 150 can be made lower than that for desktop computer user systems 150).

However, as mentioned above, any system may be used that makes a plurality of items of content available for forming a content presentation for presentation to a user. To form the content presentations, such systems may allow dynamic control (or influence) of the selection and presentation of content from those content-items.

### Formation of Content Presentations and Presentation of Content-Items

FIG. 7 schematically illustrates the structure of the content selection module 264 and its data flows according to an embodiment of the invention. FIG. 8 is a flow diagram illustrating the processing 800 performed by the content presentation software application 260, 450 in conjunction with the content selection module 264 shown in FIG. 7. This is the processing at the step S314 of FIG. 3 or FIG. 5. (It will be appreciated that the content presentation software application 260 of FIG. 2 comprises the content selection module 264, whilst the content presentation software application 450 of FIG. 4 does not comprise the content selection module 264, but rather the two may work together in communication with each other).

As mentioned above, some of the content-items 704 stored in the content-file 222 may have associated metadata 706 also stored in the content-file 222.

The processing 800 of the content selection module 264 makes use of a set 700 of one or more parameters (or variables, settings, values, data, attributes, etc.) 702 for the presentation.

Some of these parameters 702 may be so-called “system parameters” or “platform parameters” that represent factors 708 relating to the system(s) or platform(s) being used. These platform factors may include, for example:
(a1) The processing power available from the processor 164 and/or the processor 124. For example, if the user system 150 is a mobile telephone, it will have a lower processing power than if the user system 150 were a desktop computer. Additionally, the processing power available may be reduced if the processor 164, 124 is executing other processes.
(a2) The data-rate or bandwidth of the communication between the content provider system 110 and the user system 150 for the embodiment of FIGS. 4 and 5.
(a3) A display resolution of the display 174. For example, if the user system 150 is a mobile telephone, it will have a smaller display resolution than if the user system 150 were a desktop computer.
(a4) A number of audio channels and/or speakers 175 of the user system 150.
(a5) The amount of memory available for performing the processing to form and output a presentation.

Some of the parameters 702 may be so-called “user-controllable parameters” that are controllable (or that may be set or adjusted or varied or influenced) by a user of the user system 150. These user-controllable parameters 702 may include, for example:
(b1) Some of the metadata 706 for a content-item 704 may specify one or more content-types for that content-item 704. For each of the content-types specified in the content-file 222, the user may be allowed to indicate a frequency (or a probability or a relative frequency) at which content-items 704 of that content-type are to be selected by the content selection module 264. As such, there may be a user-controllable parameter 702 that indicates a frequency at which content-items 704 of a corresponding content-type are to be selected. A “content-type” for a content-item 704 may identify: a story-line for that content-item 704; a geographical location for that content-item 704; a theme for that content-item 704; or one or more people or characters related to that content-item 704; or any other type or category or classification or property for a content-item 704.
(b2) The user may be allowed to group one or more of the content-items 704 into subsets of content-items 704. As such, there may be one or more user-controllable parameters 702 that identify which content-items 704 belong to which subsets of content-items 704. One of the sub-groups could be used, for example, to limit the presentation to only those content-items 704 belonging to a particular sub-group.
(b3) The user may be allowed to control how much content from a content-item 704 is to be selected for forming the next part of the content presentation. This may involve the user specifying an upper bound on the length, or amount, of content that can be selected from a content-item 704 for forming the next part of the content presentation, in which case there may be a user-controllable parameter 702 storing that upper bound. Similarly, the user may be allowed to specify a lower bound on the length, or amount, of content that can be selected from a content-item 704 for forming the next part of the content presentation, in which case there may be a user-controllable parameter 702 storing that lower bound.
(b4) The user may be allowed to control the length of the content presentation. This may involve the user specifying an upper bound on the length of the content presentation, in which case there may be a user-controllable parameter 702 storing that upper bound. Similarly, the user may be allowed to specify a lower bound on the length of the content presentation, in which case there may be a user-controllable parameter 702 storing that lower bound. Additionally, or alternatively, the user may be allowed to specify the total number of discrete selections made by the content selection module 264 (which will ultimately determine a length for the content presentation) in which case there may be a user-controllable parameter 702 storing that number. Alternatively, the user may be allowed to specify an upper and/or a lower bound on the total number of discrete selections to make, in which case there may be corresponding user-controllable parameters 702 for these bounds.
(b5) Some user-controllable parameters 702 may be set by one or more devices (not shown) that monitor a physical condition or attribute of the user and that provide input data regarding that condition or attribute of the user to the user system 150, for example via the user-input interface 166. For example, the user system 150 may receive inputs from a heart-rate monitor connected to the user, with there then being a corresponding parameter 702 indicating a heart-rate of the user. The user system 150 could receive inputs from an eye-location-tracker, with there then being then a corresponding parameter 702 indicating a location on the display 174 which the user is currently focussed on.
(b6) The user system 150 may have required the user to login or register with a user account at, for example, the content provider system 110. In this case, there may be one or more parameters 702 that identify one or more profile attributes relating to that user account (such as age, gender, address, credit-worthiness, likes and dislikes, etc.).

Other types of parameter 702 may be used, for example:
(c1) A parameter 702 may be used to store a current position within the content presentation (such as an elapsed time from the start of the presentation to the current position within the presentation, or the length of the currently formed presentation).
(c2) A parameter 702 may be used to store the current content-type for the most recently selected content-item 704 (i.e. the content-item whose content is currently being used to form the output content presentation).
(c3) A parameter 702 may be used to identify the most recently selected content-item 704 (i.e. the content-item whose content is currently being used to form the output content presentation).
(c4) So-called “environmental parameters” that represent events or conditions or factors 708 outside of the control or influence of the user and unrelated to the system being used, such as: current weather conditions; the current time and/or date; geographical location; etc.

It will be appreciated that, in general, the parameters 702 may represent any condition, event or value considered to be of relevance, and that embodiments are not limited to the above-mentioned example parameters.

When a content-file 222 is to be played-out to a user (i.e. when content from the content-file 222 is to be presented to the user), the processing 800 starts at a step S802 at which various data is read from the content-file 222. This may involve, for example, reading the data stored in the headers of the content-file (such as the headers 600, 606, 608, 610 and 614 of the embodiment illustrated in FIG. 6). The data read from the content-file 222 may be stored in the volatile memory 156 of the user system 150 and/or in the volatile memory 116 of the content provider system 110. If enough memory is available, then some or all of the content-items stored in the content-file 222 may also be read and stored in the volatile memory 156, 116. Whilst the step S802 is not mandatory, it is useful as it allows the content selection module 264 to access the data that has been read more quickly that if it had to refer back to the content-file 222 each time it needs to access that data.

At a step S804, the content presentation software application 260, 450 determines which user controls and inputs to use, or to make available, during the content presentation, and which parameters 702 are to make up the set 700 and are to be used for the presentation. This information may be specified explicitly in the content-file 222 (for example, in the file header 600). Additionally, or alternatively, the content presentation software application 260, 450 may determine the controls and/or inputs and/or parameters 702 to use based on analysing the metadata and/or the content stored in the content-file 222. For example, the presence of certain types of metadata and/or content may imply that certain parameters 702 and/or controls and/or inputs should be used or made available (e.g. the presence of content-type metadata may imply the use of the above type-b1 parameters 702 and hence controls for those parameters).

The controls may include, for example:
A slider control (or slider-bar control)—for example: (i) a slider control could be used to vary a respective frequency value for a respective one of the above type-b1 user-controlled parameters 702; (ii) a slider control could be used to vary a bounding value for one of the above type-b3 or type-b4 user-controlled parameters 702; and (iii) a slider control could be used to vary the number of selections to be made for one of the above type-b4 user-controlled parameters 702. A slider control allows a user to specify a value for a parameter 702 within a range of values for the slider control by moving a slider bar.
A data (e.g. text or number) input area—for example: (i) an input area could be used to allow a user to enter a number representing a respective frequency value for a respective one of the above type-b1 user-controlled parameters 702; (ii) an input area could be used to enter a bounding value for one of the above type-b3 or type-b4 user-controlled parameters 702; and (iii) an input area could be used to enter the number of selections to be made for one of the above type-b4 user-controlled parameters 702. A data input area allows a user to specify a value for a parameter 702 by typing the value.
A pull down list—these lists may be used to allow a user to select a value for a parameter 702 from a predetermined list of values.
A button—for example, a button may be provided to allow a user to add or delete a subset of content-items 704 as part of the processing for the above type-b2 user-controlled parameters 702.
A check-box—for example, a check-box may be provided to allow a user to select which content-items 704 belong to a particular subset of content-items 704 as part of the processing for the above type-b2 user-controlled parameters 702.

The content selection module 264 establishes and initialises the parameters 702 that are to be used for the presentation. This may involve, for example, the use of default values (which may, for example, be specified in the content-file 222) or reading/determining current factors 708 (such as the current date, time, weather conditions, user heart-rate, etc.)

The content presentation software application 260, 450 then presents the user with an interface having the various controls 710 for the user to make use of, with these controls reflecting the values of the parameters that have been established. The controls 710 may also use one or more values specified by the content-file (such as threshold values, maximum and minimum values for a range for a slider, a default value for a data input area control, etc.) The content presentation software application 260, 450 also opens inputs 710 (channels or ports) to receive and/or request data for the various inputs which are to be used, or made available (e.g. connecting to a heart-rate monitor or an eye-location-tracker).

Next, at a step S806, the content selection module 264 determines a set 712 of filters 714 to use for the content selection processing 800. The content-file 222 may itself explicitly indicate which filters 714 are to be used for the processing 800. For example, each filter 714 may be provided with its own unique identifier and the content-file generation software application 202 may be arranged to allow a user to specify one or more filters 714 (e.g. via their unique identifiers) to be used for the content presentation, with the selected filters 714 being indicated in the content-file 222 by their corresponding unique identifiers. Additionally, or alternatively, the content selection module 264 may make this determination based on which parameters 702 and/or controls 710 and/or inputs 710 are to be used, or made available. The nature and purpose of the filters 714 shall be described in more detail below.

As an overview, the processing 800 determines a set 716 of weight-values 718. For each of the content-items 704, there is a corresponding weight-value 716. The selection of a content-item 704 to use to form part of the output presentation then uses the set 716 of weight-values 718. The weight-values are determined based, at least in part, on the parameters 702. The weight-values 718 may also be determined based on the metadata 706 associated with the content-items. The purpose of the set 712 of filters 714 is to determine the set 716 of weight-values 718.

In the rest of this description, it shall be assumed that there are M content-items 704. The i-th content-item 704 shall be referred to as content-item Cᵢ (for 1≦i≦M). The weight-value 718 for the content-item Cᵢ shall be referred to as weight wᵢ (for 1≈i≦M).

In some embodiments, the weight wᵢ for content-item C, represents the probability that the content-item Cᵢ will be selected by the content selection module 264. In this case, the weight-values 718 satisfy the property that

$${\sum }_{i = 1}^{M} {w}_{i} = 1.$$

However, it will be appreciated that other embodiments need not be so constrained. In other embodiments, if it is intended that the content-item Cᵢ is to be k times more likely to be selected than the content-item Cⱼ, then wᵢ=kwⱼ.

At a step S808, the weight-values 718 are initialised to all have the same value (so that each content-item 704 initially has the same likelihood of being selected by the content selection module 264). In the embodiment in which the weight wᵢ represents the probability that the content-item Cᵢ will be selected by the content selection module 264, then the weight wᵢ is initialised to the value of 1/M.

At a step S810, the set 716 of initialised weight-values 718 are processed by a sequence (or chain or series) of filters 714 (namely, the filters 714 determined at the step S806). This results in a set 716 of modified weight-values 718 for the content-items 704. In FIG. 7, a series of three filters 714 is illustrated, although it will be appreciated that series of filters 714 may have any number of filters 714 in accordance with the number of filters 714 determined at the step S806.

In some embodiments, each filter 714 is a processing module, executable by the processor 124, 164 that is arranged to implement a corresponding content-item selection rule. For example, the filters 714 may be implemented as objects in an object-oriented programming language. A content-item selection rule is a function for altering the weight-values 718 based one or more of the parameters 702 and, potentially, some or all of the metadata 706 according to a predetermined algorithm.

Each filter 714 has an input 720 for receiving (or requesting and obtaining) a set 716 of weight-values 718 (be that the initialised set 716 of weight-values 718 for the first filter 714 in the chain of filters 714, or a modified set 716 of weight-values 718 output from a filter 714 preceding the present filter 714 in the chain of filters 714). Each filter 714 has executable logic 722 (i.e. programming, instructions, or code) to implement a content-item selection rule that modifies the set 716 of weight-values 718 received at that filter's input 720. Examples of the logic 722 shall be given later. Each filter 714 also has an output 724 for outputting (or providing on request) the set 716 of weight-values 718 modified by the logic 722.

Furthermore, each filter 714 has an interface 726 for receiving (or requesting and obtaining) one or more of the parameters 702 for use in the processing of the logic 722 when the logic 722 applies its content selection rule to the input set 716 of weight-values 718. The interface 726 may also receive (or request and obtain) one or more items of metadata 706 for use in the processing of the logic 722 when the logic 722 applies its content selection rule to the input set 716 of weight-values 718. Furthermore, some filters 714 may be arranged to use the interface 726 to set a value for one or more of the parameters 702.

The parameters 702 may be stored at a location that all of the filters 714 can access. Additionally, or alternatively, some of the filters 714 may store their own local copy of one or more of the parameters 702. Furthermore, some of the filters 714 may store their own local variables for use throughout the processing 800.

For filters 714 that treat the weights wᵢ as probabilities, the filter logic 722 may, after applying the content-item selection rule, normalise the modified weights wᵢ so that

$${\sum }_{i = 1}^{M} {w}_{i} = 1.$$

At the step S810, the initialised set 716 of weight-values 718 is input to the first filter 714 in the chain of filters 714. This first filter 714 modifies the weight-values 714 according to its logic 722, and outputs a set 716 of modified weight-values 718 to the second filter 714 in the chain of filters. This second filter 714 modifies the received weight-values 714 according to its logic 722, and outputs a set 716 of modified weight-values 718 to the third filter 714 in the chain of filters. This process continues until all of the filters 714 have processed the set 716 of weight-values 718.

The set 716 of modified weight-values 718 indicates the probabilities (or relative likelihoods) with which the respective content-items 704 should be selected by the content selection module 264.

Once the set 716 of modified weight-values 718 has been produced by the set 712 of filters 714, a random-selector module 728 of the content selection module 264 randomly selects one of the content-items 704 to be the next content-item 704 to provide content for the content presentation. This random selection is a weighted random selection, with the selection being weighted according to the set 716 of weight-values 718 output by the set 712 of filters 714. Thus, the selection is a random selection of content in which the randomness is guided by the weight-values 718.

As the set 716 of weight-values 718 is determined based on one or more of the parameters 702, the selection is weighted based, at least in part, on these one or more parameters 702. As the set 716 of weight-values 718 may also be determined based on the metadata 706 associated with the content-items 704, the selection may also be weighted based on this metadata 706. Hence, the selection is a selection that is guided by the parameters 702 (and possibly also the metadata 706).

One way of performing the weighted random selection is as follows:

(a) A random number R is chosen in the range

$$0 \leq R < {\sum }_{i = 1}^{M} {w}_{i} .$$

(b) The content-item Cₖ is chosen, where k is the largest integer for which

$$R < {\sum }_{i = 1}^{k} {w}_{i} .$$

This method amounts to using a range of values of length L. Each of the content-items 704 is associated with a subrange of that range of values, in which the subrange associated with content-item Cᵢ has length

$$\frac{{Lw}_{i}}{{\sum }_{j = 1}^{M} {w}_{j}} .$$

A random number in that range of values is then chosen, and the content-item Cₖ is chosen if that random number lies in the subrange associated with content-item Cₖ.

The above-mentioned random number may be generated in a variety of ways. For example, the random number may be generated based on one or more of: a state of the computer 112, 152; an output of a clock of the computer 112, 152; and a seed value (in which case, the random number is pseudo-random number). The seed value may, itself, be randomly generated. Alternatively, the seed value may be input by a user via a control 710.

It will be appreciated that there are other methods for performing the weighted random selection.

At a step S814, the content selection module 264 selects a quantity of content of the selected content-item 704 to form a part of the content presentation to the user. Again, this selection may be a random selection. Alternatively, this selection may be a function of one or more of the parameters 702 (such as the above-mentioned type-b3 user controllable parameters 702). This selection may be based on other parameters 702 (such as the type-c1 parameter, so that the chosen content part commences from a suitable position within the selected content-item). Alternatively, the selection may involve selecting the entire content of the content-item 704 or a predetermined quantity of content from the content-item 704 or content from a predetermined position within the content-item 704. The particular method chosen may be indicated in the content-file 222.

At the step S814, the selection may be based on a time-criterion, i.e. content is selected from the content-item 704 based on a time associated with that content (e.g. a presentation time for a video frame or audio sample). Additionally, or alternatively, the selection may be based on one or more other criteria. For example, for image or video data, the selection may be based on a spatial-criterion in which an area (or a sub-area) of an image or a video frame is selected for output. This could be used, for example, when the content-item 704 comprises high-definition video data whilst the output is to be at standard-definition, so that a standard-definition sized area of a high-definition video frame may be selected.

The selected quantity of content from the selected content-item 704 may then be output (at the step S318 of FIG. 3 or the steps S506-510 of FIG. 5).

At a step S816, the content selection module 264 determines whether the end of the presentation has been reached (or will be reached once the content selected at the step S814 has been used in the content presentation). This may be achieved, for example, (i) by determining how long the content presentation has been (i.e. how much content had already been selected) and comparing this length with a maximum length or (ii) determining that there is no more content that can follow on from the currently selected content-item 704.

The step S816 may actually be performed by one or more of the filters 714. For example, a filter 714 may set the weight wᵢ for content-item Cᵢ to be zero if that content-item Cᵢ is not to be selected. A filter 714 may then determine, based on one or more of the parameters 702, and potentially some of the metadata 706, that a content-item Cᵢ is not to be selected, and thereby set its weight wᵢ to be zero. If all of the weights 718 are set to be zero, then no content can be selected via the steps S812 and S814, thereby indicating that the presentation has come to an end.

If the presentation has not come to an end, then processing returns to the step S808, so that a new set 716 of weight-values 718 can be determined for the content-items 704 and a fresh selection of a content-item 704 can be performed based on the newly generated set 716 of weight-values 718.

It will be appreciated that, throughout the processing 800 of FIG. 8, one or more of the parameters 702 may be changed (at a step S818), thereby potentially affecting the calculation of the weight-values 718. Such changes may occur due to, for example: (i) changes in environmental factors 708 (such as a change of available bandwidth between the content provider system 110 and the user system 150 or a change of the processing power available); (ii) the user interacting with a control 710 or providing data via an input 710; or (iii) one or more of the parameters 702 being affected by the actual play-out of content (for example, changing a parameter 702 that indicates how much content has been output or a parameter 702 that identifies the currently selected content-item 704).

It will be appreciated that the generation of the set 716 of weight-values 718 may be achieved in different ways from those described above, without the use of a chain of filters 714. However, the use of a chain of filters 714 provides a flexible, versatile mechanism for generating the weight-values 718. For example, new functionality (e.g. new content-selection rules) may be included by simply introducing one or more additional filters 714 in the chain, whilst existing functionality can be removed by simply removing a filter 714 from the chain. A general processing framework is provided in which filters 714 may be added or removed easily to vary how the content selection is achieved.

In some embodiments, there may be two or more types of content-item 704 (such as audio content-items and video content-items), and the presentation is be formed so as to simultaneously output content of each of those types (for example, displaying video with accompanying music). In this case, embodiments of the invention may make use of multiple content selection modules 264, one for each of the content-item types. In this way, content from a content-item 704 of each type may be selected to form the output presentation.

More generally, the content-items 704 from the content-file 222 may be grouped into a plurality of sub-groups (which may or may not overlap with each other). The type of content-items may be different for the various sub-groups (e.g. an audio sub-group, a video sub-group and a text sub-group). However, this need not always be the case—for example, there could be multiple sub-groups of video content-items, with a first sub-group comprising main video content, a second sub-group comprising advertising video content and a third sub-group comprising auxiliary video content. In any case, for each of these sub-groups, a content selection module 264 may be used to select content from the content-items 704 in that sub-group for forming the content presentation. The content presentation may be formed simply by arranging to output content from one sub-group at the same time as outputting content from another sub-group (such as outputting audio content at the same time as outputting video content). The content presentation may also be formed by processing some or all of the selected content to merge, or combine, that content. For example: (i) textual content (selected by one content selection module 264) may be overlaid on top of video content (selected by another content selection module 264) (for example, to provide sub-titles or advertising messages); (ii) content from a first sub-group is of video content (selected by one content selection module 264) may be chroma-keyed (or α-blended or green-screened) onto content from a second sub-group of video content (selected by another content selection module 264); (iii) image content (selected by one content selection module 264) may be overlaid on top of video content (selected by another content selection module 264) at certain positions, for example, to provide advertising messages; (iv) multiple audio content (each selected by a content selection module 264) may be mixed to provide a combined audio output (for example, to influence a stereo or surround-sound effect). In such embodiments, some or all of the multiple content selection modules 264 may operate together, in communication with each other, to provide synchronisation between the selection of content from the various sub-groups of content-items (for example, a new selection of content from a first sub-group is made whenever a new selection of content from a second sub-group is made). This may be used, for example, to synchronise audio and video output. Alternatively, or additionally, some of the content selection modules 264 may operate independently of the other content selection modules 264.

The content selections made by the various content selection modules 264 may be viewed as forming corresponding sub-presentations for the main content presentation, with the main content presentation then being formed by combining or integrating these sub-presentations.

It will be appreciated that, when one of these sub-groups of content comprises only a single content-item 704, then a content selection module 264 may be omitted for that sub-group, so that that single content-item 704 is continuously selected. However, it will be appreciated that a content selection module 264 could still be used when there is only a single content-item 704, and that doing so provides a single, generic methodology for handling all types of content-files 222 and possible sub-groups.

The sub-groups may be defined within the file structure (for example, as data within the headers of the file format 600, or due to the use of content-type sections 602, 604 within the content file 222). Alternatively, there may be one or more user-controlled parameters 702 via which the user can group content-items 704 and hence define which content-items 704 are relevant for a particular content selection module 264.

### Example for Audio and Video Content-Files

The example that follows relates to content in the form of audio and video data (for example, for music video presentations). However, it will be appreciated that this embodiment is merely an example and that the principles discussed below can apply equally to other content types and other combinations of content types.

FIG. 9 schematically illustrates a user interface 900 provided by the content presentation software application 260, 450 and displayed on the display 174. It will be appreciated that other user interfaces 900 may be used, with more, fewer or alternative features than those shown in FIG. 9.

The user interface 900 comprises a video display area 902, a character propensity control area 904, a cuts control area 906, and a playout control area 908.

The video display area 902 displays video content that has been selected for output to form the presentation. Of course, audio content that has been selected for output to form the presentation may be output via the speakers 175.

The playout control area 908 comprises standard playout controls, such as a play button 910, a pause button 912 and a presentation progress indicator 914. The presentation progress indicator 914 provides an indication of how much of the presentation has been output and how much has yet to be output. The play button 910 commences (or resumes) the processing 800, whilst the pause button 912 pauses (or interrupts) the processing 800.

For the video content-items 704 for this example content-file 222, the metadata 706 associated with those video content-items 704 indicates four distinct content-types. These four content-types identify whether a content-item 704 has a particular person (or character) in the associated video. In particular, there are four content-types for four people (Suzie, Wilfred, Benny and Marge). The metadata 706 for a video content-item 704 may have one or more of these content-types. For example, the video content-item 704 currently being output as part of the content presentation (as displayed in the display area 902) would have two content-types as two people are displayed in that video content.

A user-controllable parameter 702 may be associated with each of these content-types, with the value of that user-controllable parameter 702 being set using a corresponding slider control 916 in the character propensity control area 904. Each slider control 916 allows the user to specify a relative frequency with which content-items 704 having the corresponding content-type are to be selected for output as part of the presentation. For example, in the configuration of FIG. 9, content-items 704 involving Benny are to be selected more frequently than content-items 704 involving Marge, which are themselves to be selected more frequently than content-items 704 involving Suzie, which are themselves to be selected more frequently than content-items 704 involving Wilfred. For example, in this particular configuration, the user has selected that content-items 704 involving Benny should be output approximately twice as often as content-items 704 involving Suzie.

The content selection module 264 being used for these video content-items 704 will make use of a filter 714 for performing this character propensity control. Such a filter 714 will be described in more detail later (see example Filter 3 below).

The cuts control area 906 comprises a first slider control 918 for controlling the minimum amount of content that can be selected for output whenever a content-item 704 is selected. This slider control 918 allows the user to select a value in a range of values from a minimum value of 1 second and a maximum value of 3 seconds. These minimum and maximum values may be default values specified in the content-file 222. Similarly, the cuts control area 906 comprises a second slider control 920 for controlling the maximum amount of content that can be selected whenever a content-item 704 is selected. This slider control 920 allows the user to select a value in a range of values from a minimum value of 2 seconds and a maximum value of 15 seconds. Again, these minimum and maximum values may be default values specified in the content-file 222. With these sliders 918, 920, the user may specify a range of values for the cut-length (i.e. a range of values for the amount of content to be used from a selected content-file 704).

A user-controllable parameter 702 may be associated with the minimum and the maximum values for the cut-length, which will be used by the random selector module 728 as described above.

The cuts control area 906 also comprises a data input area 922 that allows a user to specify the number of cuts (or selections made by the content selection module 264) to use to form the content presentation. A user-controllable parameter 702 may be associated with this data input area 922. The content selection module 264 being used for these video content-items 704 will make use of a filter 714 for performing this control over the number of cuts. Such a filter 714 will be described in more detail later (see example Filter 5 below).

During the formation and output of the content presentation, the user may use the controls 916, 918, 920, 922 to dynamically control or influence how the content presentation is formed and output, as the filters 714 and the random selector module 728 are sensitive to changes in the parameters 702 being used for the presentation.

If the content-items 704 are audio-video content-items 704, then a single content selector module 264 may be used. If there are content-items 704 for the audio data that are separate from the content-items 704 for the video data, then two content selector modules 264 may be used (one to select the video content-items 704 and one to select the audio content-items 704).

### Example Filters

Below are a number of example filters 714. It will, of course, be appreciated that other filters 714 could be established and used and that the list below is not exhaustive. It will also be appreciated that the functionality of the filters 714 listed below may be achieved in other ways via other filters, potentially using different parameters 702 (or combinations of parameters 702) and/or metadata 706.
Filter 1:
   Parameter(s) 702 used: a parameter 702A indicating a current position in the presentation, e.g. an amount of time from the beginning of the presentation to the current position in the presentation, or how much content has already been selected so far for the presentation.
   Associated controls or inputs 710 used: none.
   Metadata 706 used: metadata 706A for a content-item 704 that indicates the positions in the presentation for which that content-item 704 contains content suitable for use at (or relevant to or related to) those positions. If such metadata 706A is missing, it may be assumed that the corresponding content-item 704 contains content for all positions within the presentation.
   Content-selection rule applied by the filter logic 722: for each content-item Cᵢ being processed by the content selection module 264, set its corresponding weight wᵢ to be 0 if the metadata 706A for that content-item Cᵢ indicates that that content-item Cᵢ does not contain content related to the current position within the presentation (as indicated by the above parameter 702A); otherwise, do not modify weight wᵢ.
   Purpose: used to ensure that the content selection module 264 only selects content-items 704 that have content relating to the current position in the presentation.
Filter 2:
   Parameter(s) 702 used: a parameter 702B identifying the content-item 704 currently being used to provide content for the content presentation (i.e. the content-item 704 that was most recently selected by the content selection module 264).
   Associated controls or inputs 710 used: none.
   Metadata 706 used: none.
   Content-selection rule applied by the filter logic 722: for the content-item Cᵢ identified by the above parameter 702B, set its corresponding weight wᵢ to be 0; leave the weight-values 718 for the other content-items 704 unchanged.
   Purpose: used to ensure that the currently selected content-item 704 is not selected again, i.e. the presentation definitely cuts from one content-item 704 to another, different, content-item 704. This filter 714 may be omitted if there is only one content-item 704 being processed by the content selection module 264.
Filter 3:
   Metadata 706 used: for each content-item 704, metadata 706C identifying one or more content-types for that content-item 704. A “content-type” for a content-item 704 may identify: a story-line for that content-item 704; a geographical location for that content-item 704; a theme for that content-item 704; or one or more people or characters related to that content-item 704; or any other type or category or classification or property for a content-item 704.
   Parameter(s) 702 used: for each content-type indicated by the metadata 706, a parameter 702C representing or indicating a frequency (or a frequency relative to other content-types) at which content-items 704 having that content-type should be selected by the content selector module 264 for forming part of the content presentation.
   Associated controls or inputs 710 used: a slider-bar or input data area may be provided for each parameter 702C (i.e. for each content-type).
   Content-selection rule applied by the filter logic 722: for each content-item Cᵢ, multiply its corresponding weight wᵢ by the sum of the parameters 702C for the content-types associated with that content-item Cᵢ.
   Purpose: used to allow a user to influence how often (or the likelihood that, or the relative frequency with which) content-items 704 of specific types are selected for the content presentation.
Filter 4:
   Metadata 706 used: for each content-item 704, metadata 706D identifying one or more content-types for that content-item 704. A “content-type” for a content-item 704 may identify: a story-line for that content-item 704; a geographical location for that content-item 704; a theme for that content-item 704; or one or more people or characters related to that content-item 704; or any other type or category or classification or property for a content-item 704, such as whether a video sequence was captured as a wide-angle shot or a close-up shot.
   Parameter(s) 702 used: a parameter 702D indicating the content-type(s) for the content-item 704 currently being used to provide content to form the content presentation (i.e. for the content-item 704 that was most recently selected by the content selection module 264).
   Associated controls or inputs 710 used: none.
   Content-selection rule applied by the filter logic 722:
      Option 1: for each content-item Cᵢ, reduce its corresponding weight wᵢ (e.g. set it to be zero or multiply it by a value k in the range 0≦k<1) if the parameter 702D indicates a first predetermined content-type and the metadata 706D for that content-item Cᵢ indicates a second predetermined content-type for that content-item Cᵢ; otherwise, do not modify the weight wᵢ. The first and second predetermined content-types may be the same as each other or may be different from each other.
      Option 2: for each content-item Cᵢ, reduce its corresponding weight wᵢ (e.g. set it to be zero or multiply it by a value k in the range 0≦k<1) if the parameter 702D indicates a first predetermined content-type and the metadata 706D for that content-item Cᵢ does not indicate one or more second predetermined content-type(s) for that content-item Cᵢ; otherwise, do not modify the weight wᵢ. The first and second predetermined content-types may be the same as each other or may be different from each other.
   Purpose: used to prevent (to reduce the likelihood) that content-items 704 of the second predetermined content-type following on from content-items 704 of the first predetermined content-type. For example, this filter 714 could be used to prevent cutting from a wide-angle video shot straight to another wide-angle video shot or cutting from a close-up video shot straight to another close-up video shot, i.e. to ensure that a wide-angle video shot is always followed by a close-up video shot, and vice versa. Alternatively, this filter 704 could be used to ensure (or help increase the likelihood) that, when the content-item 704 currently being used for the presentation is of a certain story-line or theme, then only content-items of that (or another suitable) story-line or theme are selected next, or, more generally, to ensure that only content-items 704 of certain content-types can be selected after the most recently selected content-item 704.
Filter 5:
   Parameter(s) 702 used: a parameter 702E storing the number of content selections to make (i.e. how many times the steps S812 and S814 are to be performed); and a parameter 702F storing the current number of content selections that have been made.
   Associated controls or inputs 710 used: a slider-bar or input data area may be provided for parameter 702E.
   Metadata 706 used: none.
   Content-selection rule applied by the filter logic 722: if the parameter 702F is less than the parameter 702E, then do not modify the weight-values 718; otherwise, set all of the weight-values 718 to be 0 to indicate that no selection of a content-item 704 should be made.
   Purpose: used to allow a user to control or influence the number of times a content-item 704 selection is made when forming the presentation.
Filter 6:
   Metadata 706 (optionally) used: for each content-item 704, metadata 706G identifying one or more content-types for that content-item 704. A “content-type” for a content-item 704 may identify: a story-line for that content-item 704; a geographical location for that content-item 704; a theme for that content-item 704; or one or more people or characters related to that content-item 704; or any other type or category or classification or property for a content-item 704, such as whether a video sequence was captured as a wide-angle shot or a close-up shot.
   Controls or inputs 710 used: controls (such as buttons, check-boxes, radio buttons, etc.) that allow a user to group one or more of the content-items 704 into content-item-groups. The user may make use of the content-types for this purpose. The content-item-groups may overlap depending on the choices made by the user.
   Parameter(s) 702 used: parameters 702G that indicate which content-item-group(s) a content-item 704 belongs to (as specified by the user); and a parameter 702H that identifies the content-item-group(s) to which the content-item 704 currently being used to form the presentation (i.e. the content-item 704 that was most recently selected by the content selection module 264) belongs.
   Content-selection rule applied by the filter logic 722: for each content-item Cᵢ, reduce its corresponding weight wᵢ (e.g. set it to be zero or multiply it by a value k in the range 0≦k<1) if the parameters 702G indicate that that content-item Cᵢ does not belong to a content-item-group identified by the parameter 702H; otherwise, do not modify the weight wᵢ.
   Purpose: allows the user to control or modify the selection of content-items 704 by ensuring (or increasing the likelihood) that the next content-item 704 to be selected is one that belongs to a content-item-group to which the currently-selected content-item 704 belongs.
Filter 7:
   Parameter(s) 702 used: parameter(s) 702J storing values for platform or environmental factors for the presentation (such as one or more of the above-described factors (a1), (a2), (a3), (a4) and (c4)).
   Metadata 706 used: metadata 706J for a content-item 704 may indicate the suitability of that content-item 704 for use under certain platform or environmental factors. For example, a content-item 704 may be unsuitable for use if the processing power available to process it is insufficient or if the display resolution of the display 174 is insufficient.
   Associated controls or inputs 710 used: none.
   Content-selection rule applied by the filter logic 722: if the metadata 706J for a content-item Cᵢ indicates that that content-item Cᵢ is unsuitable for use in the presentation, given the environmental or platform factors indicated by the parameter(s) 704J, then set the weight wᵢ for that content-item Cᵢ to be 0; otherwise, do not modify the weight wᵢ for that content-item Cᵢ.
   More generally, the metadata for a content-item Cᵢ may comprise one or more suitability factors s_{i,1} . . . s_{i,R} corresponding to various possible values assumed by one or more of the environmental or platform factors, wherein a higher value for a suitability factor indicates that the content-item Cᵢ is more suitable for the corresponding environmental or platform factor(s) value(s). The weight wᵢ for the content-item Cᵢ may then be multiplied by the suitability factors corresponding to the current environmental and/or platform factors.
   Purpose: used to ensure, or increase the likelihood, that the content selection module 264 only selects content-items 704 that are suitable for forming the presentation given the environmental conditions for the system(s) being used.
Filter 8:
   Controls or inputs 710 used: the user system 150 may use a heart-rate monitor to monitor the heart-rate of a user and to provide an indication of the heart-rate as an input to the content selection module 264.
   Parameter(s) 702 used: a parameter 702K storing the received heart-rate value.
   Metadata 706 used: for each content-item 704, metadata 706K identifying one or more content-types for that content-item 706. A “content-type” for a content-item 704 may identify: a story-line for that content-item 704; a geographical location for that content-item 704; a theme for that content-item 704; or one or more people or characters related to that content-item 706; or any other type or category or classification or property for a content-item 704, such as whether a video sequence was captured as a wide-angle shot or a close-up shot.
   Content-selection rule applied by the filter logic 722: the filter 714 may monitor the parameter 702K and, if a significant rise in the heart-rate is detected during presentation of content from a current content-item 704, then the weight-value 718 for a content-item 704 is increased (e.g. by multiplying by a value k above 1) if a content-type for that content-item 704 matches a content-type of the current content-item 704. The value of k may be increased in dependence upon the number of matching content-types.
   Purpose: used to increase the likelihood that the user is presented with content that he prefers.
Filter 9:
   Controls or inputs 710 used: the user system 150 may have required the user to login to use the content-file (for example, logging-in to the content provider system 110). As such, a profile (which could be stored at the content provider system 110) for the user may be received as an input to the content selection module 264. This profile may indicate information such as age, gender, geographical location, and other demographics or data regarding aspects of the user.
   Parameter(s) 702 used: a parameter(s) 702L storing the received user-profile data.
   Metadata 706 used: for each content-item 704, metadata 706L identifying levels of suitability of that content-item 704 relative to possible aspects of a user. For example, if a content-item 704 is more suited to women, then the metadata 706L may indicate a level of 0.8 for women and a level of 0.5 for men. If a content-item 704 is only intended for people aged over a threshold age, then the metadata 706L may indicate a level of 1 for a user above that threshold age and a level of 0 for a user below that threshold age.
   Content-selection rule applied by the filter logic 722: for each content-item Cᵢ, multiply its corresponding weight wᵢ by the levels indicated by the metadata 706L for that content-item Cᵢ that relate to one or more of the aspects of the current user (as specified in the user profile).

Purpose: used to increase the likelihood that the user is presented with content that the user prefers or that is suitable for that user.

### Additional or Alternative Features of Embodiments of the Invention

If only a single decoder module 266, 404 is used, then that decoder module 266, 404 can only be used to decode content from a selected content-item once it has finished decoding content from the previously selected content-item. This might have an impact on the manner in which content may be selected from a content-item at the step S814. For example, with long-GOP encoding of video data (in which a group-of-pictures (a GOP) is compressed by encoding one image frame by reference to itself (an I-frame) and one or more other image frames (P- or B-frames) by reference to that I-frame and possibly other P- or B-frames in that GOP), there may be an unacceptable delay (which disrupts the user's experience of the content presentation) if content is to be output starting at a point within the GOP (i.e. at a P- or a B-frame), as opposed to starting at the beginning of the GOP. This is due to the additional decoding that needs to be performed to be able to decode the frame at that point within the GOP.

In some embodiments, this problem is overcome by restricting the positions within a content-item from which the content selected at the step S814 for use in the content presentation may commence, e.g. only at the beginning of a GOP.

In an alternative embodiment, two decoder modules 266, 404 may be used. Whilst content is being decoded for output in the presentation by one of the decoder modules 266, 404 (i.e. before the output of content from a currently selected content-item has finished), the processing 800 may be executed to select the next content to output (i.e. the steps S808-814). The decoder module 266, 404 that is not currently being used for outputting to the presentation may then begin decoding the selected content from the next content-item such that the decoded content from the next content-item is ready for outputting as part of the presentation when the output of content from the currently selected content-item has finished. This may involve starting this anticipatory decoding at a predetermined period before the end of the currently selected content. In this way, the above-described roles of the two decoder modules 266, 404 may alternate throughout the presentation, e.g. (i) a first decoder module 266 performs decoding from a first content item whilst outputting that decoded content for the presentation and, in parallel, a second decoder module 266 performs decoding from a second content item in anticipation of having to output content from that second content item; (ii) then, when the output from the first content item has completed, the second decoder module 266 performs decoding from the second content item whilst outputting that decoded content for the presentation and, in parallel, the first decoder module 266 performs decoding from a third content item in anticipation of having to output content from that third content item; (iii) and so on. This embodiment would allow the content selection module 264 to select content at the step S814 starting from any point within a content-item. Additionally, when such accurate content selection is required, this embodiment allows the use of formats (such as long-GOP compression) for encoding the content-items and consequently reduces the size of the content-file 222 and/or allows more content-items to be included in a content-file 222 of a given size.

In embodiments using the above-mentioned type-b1 user-controllable parameters 702, when the content-items comprise audio content, then the audio output balance of audio content of a currently selected item of content may be adjusted based on these type-b1 parameters. For example, audio content having multiple channels or components (for example, one channel or component per person or instrument in a music band) may have the relative output levels of those channels or components adjusted according to the relative frequencies indicated by the type-b1 parameters. In this way, a channel or component that a user has indicated a preference for could be made more dominant in the output audio by raising its level in comparison with the other channels or components. To achieve this, metadata may be required to be able to associate those channels or components with the type-b1 user-controllable parameters. Additionally, the decoder module 266, 404 may require access to those type-b1 user-controllable parameters and that metadata.

As mentioned above, the random-number generator may operate based on a seed value. During a content presentation, the content selection module 264 may be arranged to store the values of the parameters 702 that are used each time the step S810 is performed. In this way, a history of the pertinent values of the parameters 702 that were used for the step S810 can be generated. This history could be arranged simply as a list of parameter values. Alternatively, this history could comprise a list of the initial parameter values, together with data identifying changes made to those parameter values. Then, the seed value used and this history of parameter values may be output as a key value, i.e. a key value may be formed, the key comprising the seed value and an indication of values assumed by the one or more parameters when performing the step S810 (to generate the weight-values 718) for the presentation.

The content presentation software application 260, 450 may allow a user to input such a key value to initialise and control a content presentation. By re-seeding the random selector module 728 with the seed value of the key, and by setting and adjusting the parameters 702 in accordance with the history of the key, the resulting content presentation will be the same as the content presentation that generated the key value. In this way, a user can store a key value that represents a content presentation that he would like to see again, or that he would like another person to see.

Whilst the above-described embodiments make use of a random-number-generator to select content, it will be appreciated that embodiments of the invention may use any method of providing a logically unpredictable selection of content.

In some embodiments of the invention, the user may be provided with the option of selecting or de-selecting the particular filters 714 being used. Thus, whilst the set 712 of filters 714 may be initialised at the step S806, the user may override the contents of this set 712 so as to remove and/or add filters 714 to/from the set 712.

It will be appreciated that, when outputting content, the transition from one selected amount of content to a next selected amount of content may be achieved in a number of ways. For example, cuts, fades, wipes, and any other type of content transition may be used. Indeed, the content selection module 262 and/or the content presentation software application 450 may select the particular transition and/or settings to use for a transition (such as duration of the transition, direction of the transition (e.g. left to right for a wipe), etc.) based on one or more of the various parameters 702 (e.g. parameters that the user has provided via the user interface), this being carried out in a similar manner to the way in which the particular content-items to present are selected. Thus, a weighted selection of the transitions used during the content presentation may be achieved. For this, one of the filters 714 used may be a filter 714 arranged to select and implement a particular transition based on one or more of the various parameters 702.

It will be appreciated that, whilst embodiments of the invention have been described that output the content presentation to a user (visually via the display 174 and/or audibly via the speakers 175) whilst the presentation is being generated, embodiments of the invention may additionally, or alternatively, output the content presentation as a media data file (for example, a flash media file or an MPEG4 file). This media data file may then be played by the user at a later time.

It will be appreciated that, insofar as embodiments of the invention are implemented by a computer program, then a storage medium and a transmission medium carrying the computer program form aspects of the invention.

As discussed above, the content presentation software application 450 (or at least the user interface module 262) running on the user system 150 displays a user interface on the display 174 via which the user may vary the one or more parameters 702 for the content presentation before and/or during the presentation of the content-items (or parts thereof). One way in which the user interface module 262 may control this at the user system 150 is as follows:
(a) The user interface module 262 may initially overlay/display an icon/button on top of a part of the content being displayed on the display 174 (preferably only a relatively small part of the content compared to the output size of the content), e.g. at the bottom right corner of the display 174. In this way, the user interface module 262 may minimize or reduce the impact that it has on the user during that period of time in which the user simply wishes to watch the content without interacting with the content presentation. Displaying only an icon/button as opposed to the full interface with which the user can modify parameters etc. helps reduce the amount of space on the display 174 that is used up by the user interface.
(b) When the user wishes to interact with the content presentation (e.g. adjust one or more of the parameters for the content presentation), then the user may select the displayed button (e.g. by navigating a cursor towards the displayed button, and then clicking on the button). When the user interface module 262 detects the selection of the displayed button, the user interface module 262 may overlap/display a full/more complete user interface on top of a part of the content being displayed on the display 174.
(c) The user may then interact with the user interface and its various controls accordingly, as has been discussed above.
(d) The user interface module 262 may be arranged to detect that a predetermined period of time has passed since the user last interacted with the displayed user interface, i.e. whether there has been a period of inactivity by the user. If the user interface module 262 makes such a detection, then it may be arranged to stop displaying the full/more complete user interface and revert to displaying only the button. Processing would then return to step (a) above.

In some embodiments, at least some of the metadata that is associated (step S304) with a video content-item (or similarly an image or text content-item) and that is stored in a corresponding content-file 222 for that content-item may identify one or more areas of interest (i.e. specific regions) within the video frames/field/images of that content-item. For example, if the video content-item depicts a car race, then the metadata associated with the video content-item may identify one or more areas within (or sub-parts of) one or more video frames, where each area corresponds to a particular location occupied by a respective car. This metadata may be manually generated or may be automatically generated. The metadata included in the content-file 222 may also include further information relevant to an area of interest (e.g. the name of the driver of the corresponding racing car). Additionally or alternatively, the metadata included in the content-file 222 may comprise a link (e.g. a URL or an index into a database or a unique identifier for that area of interest) from an area of interest to further information related to that area of interest—this further information could be stored at the content provider system 110 and the link could then be an index into a database of further information that is stored at the content provider system 110; alternatively this further information could be stored at an alternative location (such as a webpage or website) other than the content provider system 110 and the link could be a URL to that alternative location.

When such area of interest metadata is used, the user interface module 262 may be arranged to allow the user to move a cursor (or other location/position indicator) across the display 174 and to select a particular location (e.g. by moving the mouse 170 and depressing a button of the mouse 170). The user interface module 262 may then be arranged to determine whether the particular location selected by the user lies within one of the one or more areas specified by the metadata associated the content-item currently being presented to the user, i.e. whether the user has selected a position within the boundary of a region of interest as identified by the metadata for the current content-item. If not, then the user interface module 262 may be arranged to do nothing further in relation to that location selection; if so, then the user interface module 262 may be arranged to present the user with further options regarding that selected region of interest, such as displaying further information associated with that region, and/or may be arranged to adjust one or more of the parameters used by the content selection module 264 based on which area of interest was selected (e.g. increase a propensity/frequency parameter associated with a car/object/person associated with the selected area of interest).

In the embodiment of FIG. 2, the user system 150 already has the content-file 222 and so it can display further information that is stored in the content-file 222 to the user accordingly. In the embodiment of FIG. 4, the user system 150 may communicate an identification of the particular region of interest selected by the user, with the content provider system 110 then ascertaining relevant further information (as metadata from the content-file 222 or from elsewhere). The user system 150 may identify the particular region in terms of (a) the current video frame at which the user made the location selection and the particular location selected (from which the content provider system 222 can deduce the particular region of interest); or (b) a unique identifier that uniquely specifies that area of interest—this could form part of the metadata provided to the user system 150; or (c) any other means. For example, when the content-item currently being displayed is a video of a fashion show, then the areas of interest may each relate to a respective item of clothing being displayed in the video footage; when a user selects an area containing a particular item of clothing, then the user system 150 may provide an indication of the area selected to the content provider system 110; the content provider system 110 may then identify the corresponding item of clothing based on the indication of the selected area and the knowledge of the current content-item (and frame thereof) being displayed to the user; the content provider system 110 may then obtain further information relating to that item of clothing (e.g. from a database at the content-provider system 110 or from an external location, such as a website hosted by a manufacturer of the item of clothing), such as information about price, size, manufacturer, etc. Additionally, or alternatively, the content provider system 110 may instruct a separate entity (such as a website hosted by a clothing manufacturer) to supply the user system 150 directly with further information—as such, the user system 150 (and particularly the content receiver software application 250) may be arranged to implement an RSS reader module to receive and interpret various RSS feeds from various locations (both the content provider system 110 and other locations accessible via the network 190).

It will be appreciated that the user system 150 and/or the content provider system 110 may select the particular further information for presentation to the user in a weighted manner, dependent upon one or more of the current parameters 702 being used by the content selection module 264, as has been described above. In this way, the user is presented with further information that is more relevant to, or more in line with, the particular interests or desires of the user.

The user interface module 262 may be arranged to simply display the further information to the user on the display 174. However, in some embodiments, the user interface module 262 may allow the user to interact with this further information. The particular nature of the interaction, and the whether or not interaction is actually provided, may be dependent on the particular further information to be displayed to the user. For example, the user interface module 262 may allow the user to start a product purchase transaction in relation to a particular product that is associated with the selected area of interest, for example, to order, purchase and have delivered a particular item of clothing being exhibited in the displayed fashion show. In this case, the user system 150 may have been provided, along with the further information for display, details of a supplier and their pricing information for that item of clothing. The user system 150 may detect the presence of this information and may then enable the user to interact with the further information; if no such information as this has been received at the user system 150, then the user interface module 262 may not allow the user to interact with the displayed further information (as it would not know how, or with whom, to carry out the purchase transaction). Alternatively, the purchase transaction could be carried out via the content provider system 110, so that the user system 150 need not necessarily know the full particulars of the supplier of the item to be purchased. However, it will be appreciated that other methods of, and purposes for, allowing the user to interact with further information provided to the user are possible.

As has been mentioned above, content-items 704 from one or more content-files 222 may be merged or combined when forming a content presentation. As one specific example, there may be main video content content-items 704 that are to form the main part of the presentation to the user and there may be advertising content-items 704 that are to be combined with the main video content-items 704. This may involve using “banner advertising”, in which one or more advertisements (be they text, still images, or video) are overlaid on the top of, or merged with, a strip of the main video content-items. This is usually a horizontal strip at the top or the bottom of the display 174, but it could be a vertical strip along one of the sides of the display 174, although it will be appreciated that other strips could be used too. The advertising content-items 704 may be overlaid onto the main video content-items 704 so that the advertising content-items 704 scroll across (or up/down) the display 174 (e.g. in the form of scrolling text or a moving icon/logo/trademark). The choice of advertising content-items and main video content-items may be made as described above. As mentioned above, the selection of advertising content-items may be dependent on (or synchronised with) the particular video content-items being displayed—for example, when the main video content item features a sports person who is sponsored by various sponsors, then the content selection module 264 responsible for selecting the advertising content items may be directed (via various parameters 702 and weights and an associated filter) to weight the selection of advertising content-items towards those featuring the sponsors.

The use of a content selection module 264 for selecting advertising content to provide to a user system 150 means that the advertising content items 704 are selected based on the various settings/parameters 702 that the user has provided via the user interface. One advantage of this is that targeted advertising can be achieved—the advertisement content items selected by the content selection module 264 are more likely to be relevant to, and acceptable to, the user due to them having been chosen in a weighted manner based on the various settings/parameters 702 that the user has provided. However, this does not require the user to log in, or provide account details, or other personal information that may subsequently be used by advertisers in a manner that the user would not wish. Hence, more secure targeted advertising can be achieved with embodiments of the invention.

The following are some example scenario applications for embodiments of the invention. The examples provided below are with reference to the embodiments illustrated in FIGS. 4 and 5 and generally with reference to video (or audio/video) content. However, it will be appreciated that the examples may work analogously with the embodiments illustrated in FIGS. 2 and 3 and with content of types other than video (or audio/video) content. In the examples given below, the user system 150 may be a personal computer or an internet enabled television, for example. As discussed above, the content presentation software application 450 running on the user system 150 is arranged to output, via the display 174, the content that the user system 150 has received from the content provider system 110. The content provider system 110 selects, via the content selection module 264 running on the content provider system 110, the particular content to provide to the user system 150, with this selection being based (at least in part) on user-controllable parameters 702, values for which (and updates for which) are received at the content provider system 110 over the network 190 from the end user system 150.

### Example 1

The content presentation may relate to fashion, thereby providing a general, but tailorable, “fashion channel”. The metadata associated with the content-items may specify whether a video content-item relates to a catwalk, swimwear, accessories, makeup, shoes, a particular product range, a particular product manufacturer, etc., and the user interface may provide frequency control sliders, buttons, checkboxes, etc. to allow the user to adjust parameters for these content types (e.g. frequency of display parameters, as used by the above example Filter 3). The content-items may be marked-up with region of interest metadata corresponding to items of clothing/shoes/accessories etc. so that the user interface can allow the user to obtain more information on, or possibly even purchase, those items by selecting (clicking on) the relevant regions of interest.

### Example 2

The content presentation may relate to cookery, thereby providing a general, but tailorable, “cookery channel”. The metadata associated with the content-items may specify whether a video content-item relates to a wide-angle view of a chef preparing a meal, a close-up view of a chef preparing a meal, the preparation of the ingredients, the cooking process, the presentation of the cooked food, the particular meal to be prepared, etc., and the user interface may provide frequency control sliders, buttons, checkboxes, etc. to allow the user to adjust parameters for these content types (e.g. frequency of display parameters, as used by the above example Filter 3). The user interface module 262 may allow the user to view further information associated with the content presentation by selecting a button on the user interface, such as viewing a recipe and ordering/purchasing the ingredients.

### Example 3

The content presentation may relate to a car racing event, thereby providing a general, but tailorable, “car racing channel”. The metadata associated with the video content-items may specify whether a video content-item relates to a particular driver, a particular driving team, a close-up of a car, a track-side view, the driver's point of view (in car camera), a bird's eye view, a pit lane, etc., and the user interface may provide frequency control sliders, buttons, checkboxes, etc. to allow the user to adjust parameters for these content types (e.g. frequency of display parameters, as used by the above example Filter 3). The positioning within the user interface itself of the various controls (e.g. a control to select a particular driver) may be made to be dependent upon the position of the driver within the race. Similarly, the metadata associated with the audio content-items may specify whether an audio content-item relates to a general commentary, the pit-lane commentary, etc., and the user interface may provide frequency control sliders to allow the user to adjust parameters for these content types in a similar manner to the video content-items.

### Example 4

The content presentation may relate to sports in general, thereby providing a general, but tailorable, “sports channel”. The metadata associated with the video content-items may specify whether a video content-item relates to a particular sport (such as gymnastics, running, football, etc.) and the user interface may provide frequency control sliders, buttons, checkboxes, etc. to allow the user to adjust parameters for these content types (e.g. frequency of display parameters, as used by the above example Filter 3).

### Example 5

The content presentation may relate to a tennis match, thereby providing a general, but tailorable, “tennis channel”. The metadata associated with the video content-items may specify whether a video content-item relates to a particular player, whether the view is from the perspective of delivering or receiving a serve, whether the view is a wide-angle shot, a close-up or a view of the crowd, etc. and the user interface may provide frequency control sliders, buttons, checkboxes, etc. to allow the user to adjust parameters for these content types (e.g. frequency of display parameters, as used by the above example Filter 3). If this tennis match is a live event, then this tennis channel provide the user with a bespoke channel tailored to his preferences by virtue of the weighted selections made by the content selection module 264. However, if this tennis match is not a live event, then the user interface may allow the user to select, as one of the parameters, a desired winner of the event. One of the filters used by the content selection module 264 may then select the content-items on a point-by-point basis so that the series of points won by the players (sides) causes the user's desired winner to win the event. It will be appreciated that this may be performed for other point-scoring sports/games events.

### Example 6

The content presentation may relate to musical instruments in general, thereby providing a general, but tailorable, “musical instrument channel”. The metadata associated with the video content-items may specify whether a video content-item relates to a particular musical instrument, a degree of difficulty of playing the featured musical piece, whether the content-item is a close-up view of the playing of the instrument, etc. and the user interface may provide frequency control sliders, buttons, checkboxes, etc. to allow the user to adjust parameters for these content types (e.g. frequency of display parameters, as used by the above example Filter 3). In this way, the user is provided with bespoke assistance in learning to play a musical instrument at his/her current level of ability. This applies analogously to learning other activities (such as yoga).

### Example 7

The content presentation may relate to a veterinary practice, with the content-items relating to audio/video content captured live by a plurality of cameras within a veterinary practice (its waiting rooms, surgery, reception, kennels, etc.), thereby providing a tailorable, “vet channel” or a “reality vet show”. The metadata associated with the video content-items may specify the room/location of a video content-item, the type of animal involved, etc. and the user interface may provide frequency control sliders, buttons, checkboxes, data entry boxes, etc. to allow the user to adjust parameters for these content types (e.g. frequency of display parameters, as used by the above example Filter 3). Instead of using sliders, the user interface may display a plan view of the veterinary practice and the various rooms involved, with the user then being able to select one or more rooms as their preferences (e.g. a user may wish to selecting surgery rooms and/or kennels, but not select waiting rooms). This example could apply analogously to audio/video captured live in other venues, such as restaurants, hospitals, etc.

### Example 8

The content presentation may relate to wildlife in general, thereby providing a general, but tailorable, “wildlife channel”. The metadata associated with the video content-items may specify whether a video content-item relates to a particular animal, plant, species, genus, part of the world, etc., and the user interface may provide frequency control sliders, buttons, checkboxes, etc. to allow the user to adjust parameters for these content types (e.g. frequency of display parameters, as used by the above example Filter 3).

### Example 9

The content presentation may be an audio presentation in which the content-items are translations of a common text (the translations having been carried out by different people). The metadata associated with the audio content-items may specify which person carried out a translation, the particular degree of emotion used in speaking the text, whether one or more catchwords occur in the translation, etc., and the user interface may provide frequency control sliders, buttons, checkboxes, etc. to allow the user to adjust parameters for these content types (e.g. frequency of display parameters, as used by the above example Filter 3). In this way, a mixture of translations can be achieved according to the desires of a user, presenting the user with potentially new takes/interpretations on the original-language text.

As can be seen with the above examples, the end user may be effectively provided with a bespoke television/video/audio channel with which he can interact as if he were the editor/director according to his own preferences/requirements, but in an intuitive manner. This may be performed without the need for a film crew, editor, director, etc., unlike conventional television program/channel productions. In effect, the user is co-creating his own program as he interacts with the user interface. Accordingly, the content provider system 110 may provide a plethora of bespoke “channels” to various respective individual user systems 150, but all based on the same repository/collection of content-items. The various content items may be pre-recorded and already marked-up with their various metadata. On the other hand, the various content items may be generated, marked-up with metadata, and streamed live (e.g. for a live car racing event or a live tennis match or a live music concert) according to the selections made by the content selection module 264. It will be appreciated, however, that embodiments of the invention are not limited to the examples given above and that embodiments of the invention find application in many other example scenarios.

1. A method of selecting content to form a content presentation, the presentation comprising an ordered sequence of selected amounts of content, there being a plurality of items of content available for the presentation, the method comprising:
(a) for each of the items of content, determining an associated weight-value based, at least in part, on one or more parameters for the presentation;
(b) performing a weighted selection of one of the items of content, the selection being weighted in accordance with the weight-values associated with the items of content;
(c) selecting at least a part of the content of the selected item of content to be one of the amounts of content in the ordered sequence of selected amounts of content; and
(d) repeating steps (a), (b) and (c) until the presentation is complete.

2. A method according to claim 1, in which the weighted selection is a weighted random selection.

3. A method according to claim 1, comprising allowing at least one of the one or more parameters to be modified while the presentation is being formed.

4. A method according to claim 3, comprising allowing a user to modify, while the presentation is being formed, at least one of the one or more parameters.

5. A method according to claim 1, wherein each of the items of content has associated metadata and wherein the determination of the weight-values is also based on the metadata associated with the items of content.

6. A method according to claim 5, comprising determining which parameters to use for step (a) based, at least in part, on the metadata associated with the items of content.

7. A method according to claim 5, wherein the metadata associated with at least one item of content indicates one or more content-types of that item of content.

8. A method according to claim 7, wherein, for each of the content-types indicated by the metadata for the items of content:
there is an associated parameter that indicates a frequency at which items of content of that content-type should be selected; and
the weight-values are determined such that the frequency at which the weighted selection selects items of content of that content-type corresponds to the frequency indicated by the parameter associated with that content-type.

9. A method according to claim 7, wherein if the most recently selected item of content is of a first predetermined content-type, then the step of determining the weight-values is arranged to set the weight-value for any item of content of a second predetermined content-type such that the step of performing a weighted selection does not select any item of content of that second predetermined content-type.

10. A method according to claim 9, in which the second predetermined content-type equals the first predetermined content-type.

11. A method according to claim 7, in which at least one of the content-types for an item of content identifies at least one of:
a subject-matter of the content of that item of content;
a theme for the content of that item of content; and
one or more people or characters related to that item of content.

12. A method according to claim 8, in which one or more of the items of content comprise audio content and the method comprises adjusting an audio output balance of audio content of a currently selected item of content based on the parameters that indicate a frequency at which items of content of a content-type should be selected.

13. A method according to claim 1, comprising determining whether an item of content comprises content related to a current position within the presentation, and if that item of content does not comprise content related to the current position within the presentation then the step of determining the weight-values sets the weight-value for that item of content such that the step of performing a weighted selection does not select that item of content.

14. A method according to claim 1, comprising:
at step (c), randomly determining the quantity of content to select from the selected item of content.

15. A method according to claim 14, comprising allowing a user to set a lower bound and/or an upper bound on the quantity of content to select from the selected item of content.

16. A method according to claim 1, in which the items of content comprise one or more of:
video content;
one or more channels of audio content;
textual content;
graphic content; and
multimedia content.

17. A method according to claim 1, wherein step (b) comprises generating one or more random numbers based on a seed value.

18. A method according to claim 17, comprising:
forming a key for the presentation, the key comprising the seed value and an indication of values assumed by the one or more parameters when performing step (a) for the presentation.

19. A method according to claim 17, comprising:
receiving as an input a key for the presentation, the key comprising the seed value and an indication of values which the one or more parameters are to assume when step (a) is performed for the presentation; and
using the key to control the parameter values when performing step (a).

20. A method according to claim 1, in which step (a) comprises determining the weight-values based on one or more content selection rules.

21. A method according to claim 5, in which step (a) comprises determining the weight-values based on one or more content selection rules, the method comprising determining which content selection rules to use based, at least in part, on the metadata associated with the items of content.

22. A method according to claim 1, wherein the presentation of content comprises a plurality of sub-presentations of content and the method comprises selecting content to form each sub-presentation.

23. A method according to claim 1, comprising outputting the presentation to a file or to a user.

24. (canceled)

25. A method according to claim 23, in which the items of content are in an encoded form and step (c) comprises decoding the at least a part of the content of the selected item of content, wherein the method comprises:
performing step (b) before the output of content of a currently selected item of content has finished in order to select a next item of content; and
beginning to decode content of the next item of content such that the decoded content of the next item of content is ready for outputting as a part of the presentation when the output of content of the currently selected item of content has finished.

26. A method of outputting a sequence of video content, there being a plurality of items of video content available and each item of video content is of one or more content-types, the method comprising:
for each of the content-types, storing a frequency-indicator for that content-type;
performing a weighted selection of one of the items of video content, the selection being weighted so as to select items of content of a content-type with a frequency in accordance with the value of the frequency-indicator for that content-type;
outputting at least a part of the content of the selected item of video content; and
repeating the steps of performing and outputting;
wherein the method also comprises allowing a user to vary the values of the frequency-indicators during the output of the video content.

27. A method according to claim 25, in which the weighted selection is a weighted random selection.

28. A method according to claim 1, comprising performing a weighted selection of a transition from a set of available transitions for transitioning in the content presentation from a selected item of content to a subsequently selected item of content, the selection of the transition being weighted in accordance with one or more of the one or more parameters for the presentation.

29. A system arranged to select content for forming a content presentation, the presentation comprising an ordered sequence of selected amounts of content, the system comprising:
storage means storing a plurality of items of content;
a weight-value calculator arranged to calculate, for each of the items of content, an associated weight-value based, at least in part, on one or more parameters for the presentation;
a first selector arranged to perform a weighted selection of one of the items of content, the selection being weighted in accordance with the weight-values associated with the items of content; and
a second selector arranged to select at least a part of the content of an item of content selected by the first selector to be one of the amounts of content in the ordered sequence of selected amounts of content;
wherein the system is arranged to select content until the presentation is complete.

30. (canceled)

31. A system for outputting a sequence of video content, the system comprising:
storage means storing a plurality of items of video content, wherein each item of video content is of one or more content-types, the storage means also storing a frequency-indicator for each content-type;
a selector arranged to perform a weighted selection of one of the items of video content, the selection being weighted so as to select items of content of a content-type with a frequency in accordance with the value of the frequency-indicator for that content-type;
an output for outputting at least a part of the content of the selected item of video content;
the system being arranged to select and output content until the end of the presentation;
wherein the system also comprises a user interface arranged to allow a user to vary the values of the frequency-indicators during the output of the video content.

32-35. (canceled)

36. A computer readable storage medium tangibly storing a computer program which, when executed by a processor, causes the processor to carry out a method of selecting content to form a content presentation, the presentation comprising an ordered sequence of selected amounts of content, there being a plurality of items of content available for the presentation, the method comprising:
(a) for each of the items of content, determining an associated weight-value based, at least in part, on one or more parameters for the presentation;
(b) performing a weighted selection of one of the items of content, the selection being weighted in accordance with the weight-values associated with the items of content;
(c) selecting at least a part of the content of the selected item of content to be one of the amounts of content in the ordered sequence of selected amounts of content; and
(d) repeating steps (a), (b) and (c) until the presentation is complete.
